(19) United States
(12) Patent Application Publication
(10) Pub. No.: US 2011/0127915 A1
(43) Pub. Date: Jun. 2, 2011

(54) PLASMA CONTAINMENT

(76) Inventors: W. Farrell Edwards, Logan, UT (US); Eric D. Held, Logan, UT (US)

(21) Appl. No.: 12/914,165

(22) Filed: Oct. 28, 2010

Related U.S. Application Data
(63) Continuation-in-part of application No. 11/624,672, filed on Jan. 18, 2007, now abandoned.

(51) Int. Cl. H05H 1/30

(52) U.S. Cl. 315/111.71

(57) ABSTRACT

A method and apparatus are disclosed for plasma containment. A toroidal vacuum device is filled with the gas. Field coils generate a toroidal magnetic field. An ionizing device ionizes the gas into a plasma. A transformer inductively drives a toroidal first particle current about a toroidal axis that heats the plasma and generates a poloidal magnetic field. The field coils restrict the toroidal magnetic field to a boundary value. The poloidal magnetic field and the toroidal magnetic field motivate the first particles radially inward toward a toroidal axis, producing a radial electric field. The radial electric field, the poloidal magnetic field, and the toroidal magnetic field contain the plasma within the toroidal vacuum device in a minimum-energy state.

### CROSS-REFERENCE TO RELATED APPLICATIONS

This application is a continuation-in-part of U.S. patent application Ser. No. 11/624,672, filed 18 Jan. 2007 for W. Farrell Edwards et al, entitled “Plasma Containment Methods,” incorporated herein by reference, which claims priority to U.S. patent application Ser. No. 10/804,520, filed 19 Mar. 2004 for W. Farrell Edwards et al. and entitled “Systems and Methods of Plasma Containment,” incorporated herein by reference. Application Ser. No. 10/804,520, in turn, claims priority benefit of U.S. provisional patent application No. 60/456,832, filed 21 Mar. 2003 for W. Farrell Edwards et al. and entitled “A Method of Obtaining Design Parameters for a Compact Thermonuclear Fusion Device,” incorporated herein by reference.

### BACKGROUND

1. Field

The subject matter disclosed herein relates to plasma containment and more particularly relates to containing a stable plasma.

2. Description of the Related Art

A stable plasma has many research uses. Unfortunately, creating and maintaining a stable, long-lived plasma can be difficult.

### BRIEF SUMMARY

From the foregoing discussion, it should be apparent that a need exists for a method and apparatus for plasma containment. Beneficially, such a method and apparatus would contain a stable plasma.

The present invention has been developed in response to the present state of the art, and in particular, in response to the problems and needs in the art that have not yet been fully solved by currently available plasma containment methods. Accordingly, the present invention has been developed to provide a method and apparatus for plasma containment that overcome many or all of the above-discussed shortcomings in the art.

A method is presented for plasma containment. The method comprises the steps of filling a toroidal vacuum device with a major radius R and a minor radius a with a gas having an initial particle density n. The initial particle density n=(mη²)/(a²μₒe²), where m is a mass of an individual charge carrier, μ₀ is the permeability of free space, e is the electron charge, and η is a constant in the range of 1 to 2.

The method further comprises the steps of generating a toroidal magnetic field with field coils wound poloidally about the toroidal vacuum device and ionizing the gas into a plasma comprising first particles and second particles. In addition, the steps of the method include inductively driving a toroidal first particle current about a toroidal axis that heats the plasma and generates a poloidal magnetic field and restricting the toroidal magnetic field to a boundary value such that a first beta value β_{θ} for the toroidal magnetic field and a second beta value β_{φ} for the poloidal magnetic field approximately satisfies the equation 1/β_{φ}=1/β_{φ}(0)[1−(1/β_{θ})/(1/β_{θ}(0))], wherein 1/β_{φ}(0) is greater than 0 and less than 3, 1/β_{θ}(0) is greater than 0 and less than 30, and an average plasma temperature is in the range of 0.1 electron volts (eV) to 100 eV.

The method further includes the steps of motivating the first particles radially inward toward the toroidal axis in response to the poloidal magnetic field and the toroidal magnetic field, separating the first particles radially inward from the second ions, the first particles contained within an inner boundary and the second particles contained within an outer boundary, and producing a radial electric field within the plasma between the radially inward first particles and the radially outward second particles and containing the plasma with the radial electric field, the poloidal magnetic field, and the toroidal magnetic field within the toroidal vacuum device in a minimum-energy state within the outer boundary of between 1 and 2 first particle skin depths.

The apparatus for plasma containment comprises a plurality of elements, including a toroidal vacuum device, field coils, an ionizing device, and a transformer. The toroidal vacuum device, with a major radius R and a minor radius a, is filled with a gas having an initial particle density n. The initial particle density n=(mη²)/(a²μₒe²), where m is a mass of an individual charge carrier, μ₀ is the permeability of free space, e is the electron charge, and η is a constant in the range of 1 to 2.

The field coils are wound poloidally about the toroidal vacuum device and generate a toroidal magnetic field. The ionizing device ionizes the gas into a plasma comprising first particles and second particles. The transformer inductively drives a toroidal first particle current about a toroidal axis that heats the plasma and generates a poloidal magnetic field.

The field coils restrict the toroidal magnetic field to a boundary value such that a first beta value β_{θ} for the toroidal magnetic field and a second beta value β_{φ} for the poloidal magnetic field approximately satisfies the equation 1/β_{φ}=1/β_{φ}(0)[1−(1/β_{θ})/(1/β_{θ}(0))]. 1/β_{φ}(0) is greater than 0 and less than 3, 1/β_{θ}(0) is greater than 0 and less than 30, and an average plasma temperature is in the range of 0.1 electron volts (eV) to 100 eV.

The poloidal magnetic field and the toroidal magnetic field motivate the first particles radially inward toward the toroidal axis, separating the first particles radially inward from the second ions. The first particles are contained within an inner boundary and the second particles contained within an outer boundary, producing a radial electric field within the plasma between the radially inward first particles and the radially outward second particles. The radial electric field, the poloidal magnetic field, and the toroidal magnetic field contain the plasma within the toroidal vacuum device in a minimum-energy state within the outer boundary of between 1 and 2 first particle skin depths.

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 shows a contained plasma having a bulk radial electric field produced inside the plasma due to a difference in the spatial distributions of electrons and ions;

FIG. 2 shows one embodiment of a process for determining a steady-state equilibrium of the plasma having the bulk E-field;

FIG. 3 shows one embodiment of a contained plasma having a cylindrical symmetry such that the electron and ion densities depend on radial distance r from the Z axis;

FIG. 4A shows a Z-pinch containment of the cylindrically symmetric plasma of FIG. 3;

FIG. 4B shows a theta-pinch containment of the cylindrically symmetric plasma of FIG. 3;

FIG. 5 shows how a high aspect ratio toroidal containment may be estimated by a cylindrical geometry;

FIG. 6 shows one embodiment of an azimuthal magnetic field profile that provides a Z-pinching;

FIG. 7 shows one embodiment of a stable confinement of electrons by a magnetic force that substantially offsets forces due to E-field and pressure;

FIG. 8 shows one embodiment of a stable confinement of ions by an electrostatic force that substantially offsets a force due to pressure;

FIG. 9A shows one embodiment of a E-field profile that results from different spatial distributions of confined electrons and ions;

FIG. 9B shows the electron and ion distributions of FIG. 9A on a logarithmic scale;

FIG. 10 shows one embodiment of a temperature profile showing how heat loss to a containment wall located relatively close to the plasma can be reduced;

FIG. 11 shows one embodiment of a contour plot of a plasma parameter 1/α as a function of Y/Λₑ and temperature T;

FIG. 12 shows one embodiment of a magnetic field profile of an axially directed magnetic field that theta-pinches the plasma;

FIG. 13 shows examples of different electron and ion distributions in the theta-pinched plasma;

FIG. 14 shows an example of an E-field profile that results from the different electron and ion distributions of FIG. 13;

FIGS. 15A-C show various scales of plasma containment facilitated by radial electric field s produced by separation of charges;

FIG. 15D shows one embodiment of an reversed plasma configuration where the ions are magnetically confined and the electrons are confined by an radial electric field, wherein such a plasma can be scaled to an ion scale length that is substantially greater than the electron scale length;

FIGS. 16A and B show one embodiment of a Z-pinch plasma containment device that can yield different electron and ion distributions;

FIGS. 17A and B show one embodiment of a theta-pinch plasma containment device that can yield different electron and ion distributions;

FIG. 18 shows one embodiment of a tokamak-type containment device;

FIG. 19 shows another embodiment of a tokamak-type containment device;

FIG. 20 is a side view drawing of one embodiment of a containment apparatus;

FIG. 21 is a cut-away drawing of one embodiment of a containment apparatus;

FIG. 22 is a side view drawing of one embodiment of the containment apparatus with poloidal field coils.

FIG. 23 is a schematic top-view drawing of one embodiment of a toroidal magnetic field;

FIG. 24 is a schematic cutaway drawing of one embodiment of the poloidal magnetic field.

FIG. 25 is a schematic cutaway drawing illustrating one embodiment of a separation of particles;

FIG. 26 is a graph showing a toroidal/poloidal minimum-energy state relationship;

FIG. 27 is a schematic flow chart diagram showing one embodiment of a plasma containment method;

FIG. 28 is a collection of graphs showing the profile of various plasma parameters as a function of time, first in a tokamak-like containment state, second in the minimum-energy containment state; and

FIG. 29 shows one embodiment of a device that can emit various outputs based on a plasma where ion confinement is facilitated by a substantial radial electric field.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. These computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

The present teachings generally relate to systems and methods of plasma confinement at a relatively stable equilibrium. In one aspect, such a plasma includes a substantial internal radial electric field that facilitates the stability and confinement of the plasma.

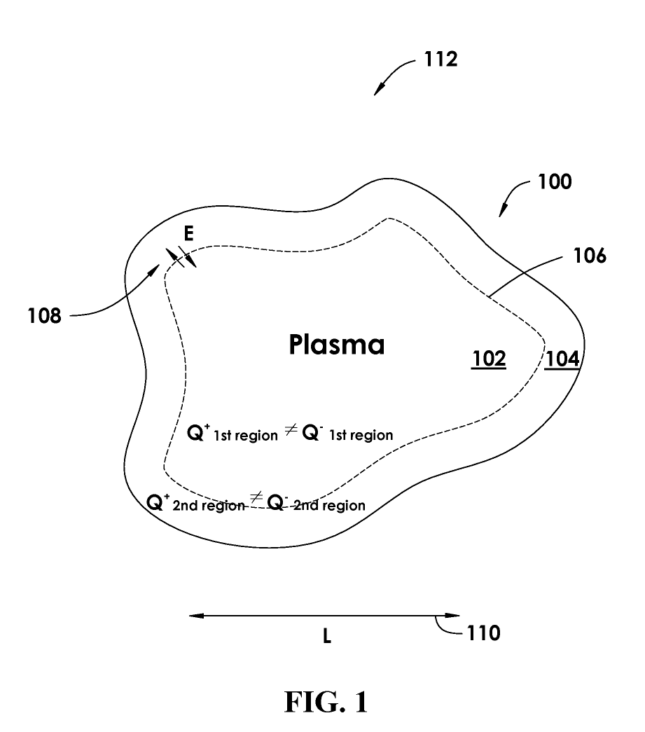

FIG. 1 shows a confined plasma 100 confined by a containment system 112. The plasma 100 defines a first region 102 substantially bounded by a boundary 106, and a second region 104 substantially bounded by the internal boundary 106 and the plasma's boundary. The plasma 100 has at least one dimension on the order of L as indicated by an arrow 110.

For the purpose of description, the plasma 100 can be characterized as a two-fluid system having an electron fluid (a fluid of a first particle species) and an ion fluid (a fluid of a second particle species). It will be understood that the ion fluid can involve one, two, or more species of ions based on the same or different elements and/or isotopes. It will also be understood that the collective fluid-equation of characterization of the plasma herein is simply one way of describing a plasma, and is in no way intended to limit the scope of the present teachings. A plasma can be characterized using other methods, such as a kinetic approach, as will be apparent to those skilled in the art in light of this disclosure.

As shown in FIG. 1, the plasma 100 is depicted as being in an internally non-quasi-neutral stable state, where in the first region 102, the integrated charge due to electrons Q⁻_{first region} is different than the integrated charge due to ions Q⁺_{first region}. Similarly in the second region 104, Q⁻_{second region} is significantly different than Q⁺_{second region}. The excess charge in the first region 102 is of opposite sign and is approximately equal in magnitude to the excess charge in the second region 104, thereby making the plasma 100, as a whole, substantially neutral.

As further shown in FIG. 1, the formation of excess charges of different signs about the internal boundary 106 causes a formation of a bulk internal radial electric field depicted as arrows 108. If one uses a convention where an E-field points away from a positive charge and towards a negative charge, the E-field 108 would point inward about the boundary 106 if the first region 102 has excess electrons (and the second region 104 has excess ions). Conversely, the E-field 108 would point outward about the boundary 106 if the first region 102 has excess ions. Both possibilities are described below in greater detail.

As described herein, formation of such radial electric field s within the plasma 100 contributes to the energy of the plasma system. Determining a relatively-stable energy state of such a system yields plasma parameters, including selected ranges of a plasma dimension L, that are substantially different than that associated with conventional plasma systems. It is generally known that static electric fields in a plasma typically do not exist over a distance substantially greater than the Debye length. They are shielded out because of rearrangements of electrons and ions. This, however, is in the absence of external forces. In the present disclosure described herein, the plasma dimension L is generally greater than many Debye lengths; however this is permitted because of the presence of external forces due to, for example, presence of magnetic fields.

In the description below, various embodiments of plasma systems are described as cylindrical and toroidal systems. In the present disclosure a cylindrical geometry is used for a simplified description, and is not to be construed as limiting in any manner. Because at least some of the effects described herein depend on the scale of the contained plasma, many arbitrary shapes of a contained plasma can be used in connection with the present disclosure. As an example, the plasma 100 in FIG. 1 is depicted as a “generic” shaped volume manifesting the internal radial electric field effect by being contained appropriately at a scale on the order of L and given the associated plasma parameters.

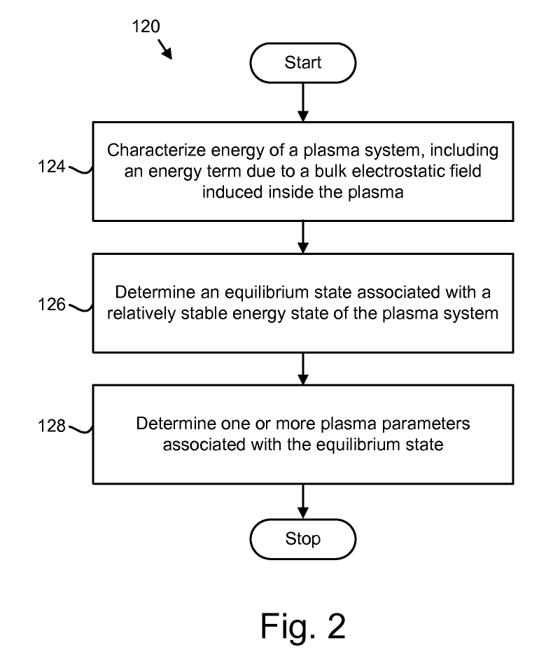

One aspect of the present teachings relates to a method for determining a plasma state that is relatively stable and wherein such stability is facilitated by formation of a relatively substantial internal radial electric field. FIG. 2 shows one embodiment of a process 120 that determines such a stable state and one or more associated plasma parameters. The process 120 begins at a start state 122, and in a process block 124 that follows, the process 124 characterizes an energy of a plasma system. The energy characterization includes an energy term due to a substantial radial electric field produced inside the plasma. In a process block 126 that follows, the process 120 determines an equilibrium state associated with a relatively stable energy state of the plasma system. In a process block 128 that follows, the process 120 determines one or more plasma parameters associated with the equilibrium state. The process 120 ends in a stop state 130.

One way to characterize the energy of the plasma system is to use a two-fluid approach without the quasi-neutrality assumption. In conventional approaches, quasi-neutrality is assumed such that electron and ion density distributions are substantially equal. In contrast, one aspect of the present teachings relates to characterizing the two-fluid system such that the electron and ion densities are allowed to vary independently substantially throughout the plasma. Such an approach allows the two fluids to be distributed differently, and thereby produce a bulk radial electric field at an equilibrium state of the plasma.

For a plasma contained at least partially by a magnetic field, the energy U of the system can be expressed as an integral of a sum of an E-field energy term, a B-field energy term, kinetic energy terms of the two fluids, and energy terms associated with pressures of the two fluids. Thus,

$$U = \int [ \frac{{ɛ}_{0} {E}^{2}}{2} + \frac{{B}^{2}}{2 {μ}_{0}} + {\sum }_{s} ( \frac{{m}_{s} {n}_{s}}{2} {u}_{s}^{2} + {p}_{s} ) ] d V \qquad ( 1 )$$

where E represents the electric field strength, εₒ represents the permittivity of free space, B represents the magnetic field strength, μₒ represents the permeability of free space, the summation index and subscripts s denote the species electrons e or ions i, mₛ represents the mass of the corresponding species, nₛ represents the particle density of the corresponding species, uₛ represents the velocity of the corresponding species, pₛ represents the pressure of the corresponding species fluid, and dV represents the differential volume element of the volume of plasma.

For the purpose of description herein, it will be understood that terms “particle density,” “number density,” and other similar terms generally refer to a distribution of particles. Terms such as “electron density” and “electron number density” generally refer to a distribution of electrons. Terms such as “ion density” and “ion number density” generally refer to a distribution of ions. Furthermore in the description herein, terms such as “average particle density” and “average number density” are used to generally denote an average value of the corresponding distribution.

Plasmas that are partially ionized and therefore contain a third species comprised of neutral particles may often behave in the manner specified herein. The Venus diamagnetism and flux ropes observed by the Pioneer 12 Venus Orbiter (“Orbiter”) provide an example of plasma containment in a minimum-energy state with partial-ionization. The Orbiter orbited Venus from 1978 until 1992, taking measurements that included particle density, temperature, and magnetic field strength. Because Venus has no intrinsic magnetic field, the magnetic fields measured were of solar origin.

The Orbiter detected flux ropes with diameters of 10 kilometers and lengths of possibly hundreds to thousands of kilometers. The flux ropes contained stably partially ionized plasma for extended periods. The particle densities, temperature, magnetic fields, and radius of the Venus flux ropes satisfy the criteria for stable plasma containment in a minimum-energy state as described herein. Many space-plasma structures including the Venus flux ropes provide evidence of the minimum-energy state described herein. C. T. Russell gives excellent descriptions the Venus flux ropes from measurements of the Orbiter. C. T. Russell, “Magnetic Flux Ropes in the Ionosphere of Venus,” Physics of Magnetic Flux Ropes, C. T. Russell, editor, pp. 413-423. See also H. Y. Wei, C. T. Russell, T. L. Zhang, M. K. Dougherty, “Comparison study of magnetic flux ropes in the ionospheres of Venus, Mars, and Titan,” Icarus 206, 2010, Institute of Geophysics and Planetary Physics, pp. 174-181.

The Venus flux ropes are distinguished from the embodiments described herein by having a high magnetic field in the center of the flux rope. In addition, the Venus flux ropes are formed by achieving an alternative set of magnetic boundary conditions than those used to create the minimum-energy state plasma containment of the embodiments herein although the density, minor radius, and temperature conditions are the same. The magnetic boundary conditions are, in effect, switched from axis to outer diameter and vise versa. Nevertheless, the existence of the Venus flux ropes validate stable plasma containment within the minimum-energy state, including with partially ionized plasmas. The flux ropes require the proper beta conditions (herein) and are driven by axial currents in each flux rope in addition to relaxation to the minimum energy state (see [0096], [0200] to [0205])

The degree of ionization in this region of the Venus ionosphere is less than 1%. The fact that the plasma behavior in that system fits very well one embodiment (i.e., ion mode) herein substantially demonstrates the validity of the minimum-energy state plasma containment even in such partially-ionized plasmas.

One way to further characterize the two-fluid plasma of this example is to treat the system as being a substantially collisionless and substantially fully-ionized plasma in a steady-state equilibrium. Moreover, each species of the two fluids can be characterized as substantially obeying an adiabatic equation of state expressed

pₛ=Cₛnₛ^{γ} (2)

where the Cₛ represents a constant that can be substantially determined by a method described below, and γ represents the ratio of specific heats of the two species. Temperatures associated with the two species can be determined through an ideal gas law relationship

pₛ=nₛkTₛ (3)

where k represents the Boltzmann's constant. Furthermore, both species are assumed to be substantially Maxwellian.

One way to further characterize the plasma is to express, for each species, a substantially collisionless, equilibrium force balance equation as

mₛnₛ(uₛ·∇)uₛ=qₛnₛ(E+uₛ×B)−∇pₛ (4)

where mₛ represents the particle mass of species s, qₛ represents the charge, uₛ represents the fluid velocity, and where the anisotropic part of the stress tensor can be and is ignored for simplicity for the purpose of description.

One way to further characterize the plasma is to express, for the system, Maxwell's equations as

$$\begin{matrix}∇ \cdot E = {\sum }_{s} {q}_{s} {n}_{s} / {ɛ}_{o} ; & ( 5 ) \\ ∇ \times B = {μ}_{O} {\sum }_{s} {q}_{s} {n}_{s} {u}_{s} ; & ( 6 ) \\ ∇ \times E = 0 ; \\ and & ( 7 ) \\ ∇ \cdot B = 0. & ( 8 )\end{matrix}$$

As is known, Equation (5) is one way of expressing Poisson's equation; Equation (6) is one way of expressing Ampere's law for substantially steady-state conditions; Equation (7) is one way of expressing the irrotational property of an electric field which follows from Faraday's Law for substantially steady-state conditions; and Equation (8) is one way of expressing the solenoidal property of a magnetic field.

As is also known, Maxwell's equations assume conservation of total charge of a system. Accordingly, one can introduce a dependent variable Q defined as

∇·Q=nₑ (9)

to substantially ensure electron conservation by adopting appropriate boundary conditions in a manner described below. The electron density nₑ can further be characterized as obeying a relationship nₑ≧0.

One way to determine a relatively stable confinement state of a plasma system is to determine an equilibrium state that arises from a first variation of the total energy of the plasma system as expressed in Equation (1) subject to various constraints as expressed in Equations (2)-(9). For the present invention, total energy may be defined as the combination of energy associated with pressure due to the temperature of the plasma particles, in this case ions and electrons, energy stored in the net electric field, energy stored in the net magnetic field, and kinetic energy associated with the movement of the plasma particles, in this case ions and electrons. In one such determination, the pressure term in Equations (1) and (4) can be eliminated by using Equation (2). The resulting constraints can be adjoined to the resulting energy expression U by using Lagrange multiplier functions. Such a variational procedure generally known in the art can result in a relatively complex general vector form of nonlinear differential equations.

One way to simplify the variational procedure without sacrificing interesting properties of the resulting solutions is to perform the procedure using cylindrical coordinates and symmetries associated therewith. The cylindrical symmetries can be used to reduce the independent variables of the system to one variable r. Accordingly, dependent variables of the system can be expressed as nᵢ, nₑ, Eᵣ, B_{z}, B_{θ}, Q, u_{iz}, u_{iθ}, u_{ez}, and u_{eθ}, where subscripts i and e respectively represent ion and electron species. The first six are state variables. Because derivatives of the last four (velocity components) do not appear in Equations (11A)-(11P) they can be treated as control variables in a manner described below.

Applying the cylindrical symmetries to the plasma system (where constraints ∇×E=0 and ∇·B=0 of Equations (7) and (8) are substantially satisfied identically), cylindrical coordinate expressions associated with Equations (4)-(6) and (9) can be adjoined to U of Equation (1) using Lagrange multiplier functions Mᵢ, Mₑ, M_{E}, M_{z}, M_{θ} and M_{Q}. As the name implies, variations of the control variables may be considered as producing variations in the state variables as well as in the Lagrange multiplier functions.

The variation of U leads to first-order differential equations for the state variables and for the Lagrange multiplier functions, and to algebraic equations for the control variables. Such equations can conveniently be expressed as equations in dimensionless form using the following replacements: r→rΛₑ, uₛ→uₛc, n→N₀n, E→EeN₀Λₑ/ε₀, B→BeN₀Λₑμ₀c. Cₛ→Cₛmₑc²N₀^{1-γ}, pₛ→pₛmₑN₀c², Q→QΛₑ and T→Tₛk/mc², where c represents the speed of light, N₀ represents the average particle density, e represents the magnitude of the electron charge, and Λₑ represents the electron skin depth expressed as

Λₑ=(mₑ/μₒN₀ e²)^{1/2}. (10)

One system of equations that follows from the foregoing energy variation method can be expressed as

dMₑ/dr=−ru_{ez}²/2−M_{θ}u_{ez}−ru_{eθ}²/2+M_{z}u_{eθ}−M_{E}−M_{Q}−Cₑrγnₑ^{γ-1}−Mₑ(Cₑγ)⁻¹(2−γ)nₑ^{1-γ}(Eᵣ+u_{eθ}B_{z}−u_{ez}B_{θ}+u_{eθ}²/r) (11A)

dMᵢ/dr=−ru_{iz}²/2−M₀u_{iz}−ruᵢ₀²/2+M_{z}u_{iθ}+M_{E}−Cᵢrγnᵢ^{γ-1}+Mᵢ(Cᵢγ)⁻¹(2−γ)nᵢ^{1-γ}(Eᵣ+u_{iθ}B_{z}−u_{iz}B_{θ}+u_{iθ}²/r) (11B)

dM_{E}/dr=−rEᵣ−Mₑnₑ^{2-γ}(Cₑγ)⁻¹+Mᵢnᵢ^{2-γ}(Cᵢγ)⁻¹−M_{E}/r (11C)

dM_{z}/dr=−rB_{z}−Mₑnₑ^{2-γ}u_{eθ}(Cₑγ)⁻¹+Mᵢnᵢ^{2-γ}u_{iθ}(Cᵢγ)⁻¹ (11D)

dM_{θ}/dr=−rB_{θ}+Mₑnₑ^{2-γ}u_{ez}(Cₑγ)⁻¹−Mᵢnᵢ^{2-γ}u_{iz}(Cᵢγ)⁻¹+M_{θ}/r (11E)

dM_{Q}/dr=M_{Q}/r (11F)

u_{ez}={Mₑnₑ^{1-γ}B_{θ}(Cₑγ)⁻¹−M_{θ}}/r (11G)

u_{eθ}={M_{z}−Mₑnₑ^{1-γ}(rCₑγ)⁻¹}/{r+2Mₑnₑ^{1-γ}(rCₑ)⁻¹} (11H)

u_{iz}={Mᵢnᵢ^{1-γ}B_{θ}(Cᵢγ)⁻¹−M_{θ}}/r (11I)

u_{iθ}={M_{z}−Mᵢnᵢ^{1-γ}(rCᵢγ)⁻¹}/{r+2Mᵢnᵢ^{1-γ}(rCᵢ)⁻¹} (11J)

dnₑ/dr=−(Cₑγ)⁻¹nₑ^{2-γ}(Eᵣ+u_{eθ}B_{z}−u_{ez}B_{θ}−u_{eθ}²/r) (11K)

dnᵢ/dr=(Cᵢγ)⁻¹nᵢ^{2-γ}(Eᵣ+u_{iθ}B_{z}−u_{iz}B_{θ}+u_{iθ}²/r) (11L)

dEᵣ/dr=−Eᵣ/r+nᵢ−nₑ (11M)

dB_{z}/dr=nₑu_{eθ}−nᵢu_{iθ} (11N)

dB_{θ}/dr=−B_{θ}/r+nᵢu_{iz}−nₑu_{ez} (11O)

dQ/dr=−Q/r+nₑ (11P)

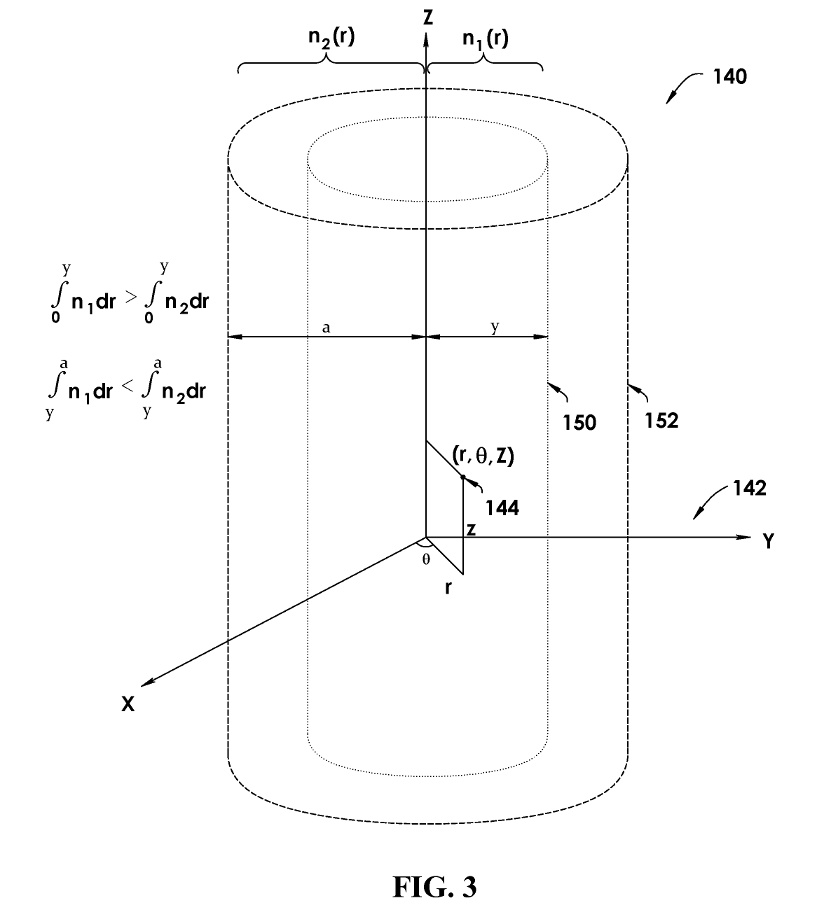

One set of boundary conditions (at r=0 and r=a, where a is defined as an outer boundary in FIG. 3) includes Eᵣ(0)=Eᵣ(a)=0, B_{z}(a)=B₀, and B_{θ}(0)=0. Boundary conditions can further include Q(0)=0 and Q(a)=N₀a/2 relating to charge conservation for individual species. Conditions at each boundary can further be imposed on each state variable or its corresponding Lagrange multiplier function so as to be substantially equal to zero if there is substantially no state-variable condition. It follows that Mₑ(0)=Mₑ(a)=Mᵢ(0)=Mᵢ(a)=M_{z}(0)=0.

In one implementation of a method for determining a stable equilibrium of the foregoing cylindrical plasma system, input parameters (expressed in dimensional form) for solving the system of equations (Equations (11A-P)) include the cylindrical radius a, the average particle number density N₀ substantially equal for both species, the axial magnetic field at the boundary a such that B_{z}(a)=B₀, the net axial current I, and a temperature value T₀ for both electrons and ions that is the temperature taken at that value of r at which nₛ=N₀. Using these input parameters, one can determine that B_{θ}(a)=μ₀I/(2πa).

Furthermore, the values of Cₛ can be determined by combining the adiabatic equation of state from Equation (2) and the ideal gas law from Equation (3) so as to yield Cₛ=nₛ^{1-γ}kTₛ. Thus, Cₛ=N₀^{1-γ}kT₀ when evaluated at the value of r where nₛ=N₀ and Tₛ=T₀. The electron and ion average temperatures may be different, which would result in different values of Cᵢ and Cₑ. For the examples of the present disclosure, they are taken to be substantially the same, i.e., T₀. Such a simplification for the purpose of description should not be construed to limit the scope of the present teachings in any manner.

Another useful set of input parameters can be obtained by replacing B₀ with a plasma beta value defined as β=N₀kT₀/(B₀²/2μ₀) (in the geometry of FIG. 3, an azimuthal beta value) and by replacing I with another beta value α=N₀kT₀/(B_{θ}(a)²/2μ₀) (in the geometry of FIG. 3, an axial beta value), where I=2πaB_{θ}(a)/μ₀. Note that 1/β=0 corresponds to a substantially pure Z-pinch, and 1/α=0 corresponds to a substantially pure theta-pinch. A screw-pinch corresponds to substantially nonzero values for both 1/α and 1/β.

The foregoing energy variational method yields a description of the plasma system by twelve first-order coupled nonlinear ordinary differential equations, four algebraic equations, and one inequality condition (nₑ≧0), with sixteen unknowns. Numerical solutions to such a system of equations can be obtained in a number of ways. Solutions disclosed herein are obtained using a known differential equation solving routine such as BVPFD that is part of a known numerical analysis software IMSL.

FIG. 3 now shows one embodiment of a cylindrically shaped contained plasma 140 that embodies a possible solution to the energy variation analysis of the two-fluid system described above. As a reference, the cylindrical plasma 140 is superimposed with a cylindrical coordinate system 142. An arbitrary point 144 on the coordinate system 142 can be expressed as having coordinates (r, θ, z).

The plasma 140 defines a first cylindrical volume 150 extending from the Z-axis to r=Y, and a second cylindrical volume 152 extending from the Z-axis to r=α. The first volume 150 generally corresponds to a region of the plasma 140 where the first species of the two fluids is distributed as n₁(r). The second volume 152 generally corresponds to a region of the plasma 140 where the second species of the two fluids is distributed as n₂(r).

In general, the first and second species are distributed such that

$$\begin{matrix}{\int }_{0}^{Y} {n}_{1} d r > {\int }_{0}^{Y} {n}_{2} d r , & ( 12 A ) \\ {\int }_{Y}^{a} {n}_{1} d r = 0 , & ( 12 B ) \\ {\int }_{0}^{a} {n}_{1} d r = {\int }_{0}^{a} {n}_{2} d r . & ( 12 C )\end{matrix}$$

That is, the first region 150 has more of the first species than the second species, and the portion of the second region 152 outside of the first region has substantially none of the first species. As Equation (12C) shows, the total number of particles in the two species is substantially the same in one embodiment.

In some embodiments, substantially all of the first species is located within the first region 150 such that r=Y defines a boundary for the first species. Consequently, the region Y<r<a has substantially none of the first species, and is populated by the second species by an amount ΔN. Since the total numbers of the first and second species are substantially the same in one embodiment, the value of ΔN is also representative of the excess number of the first species relative to the second species in the first region 150.

In some embodiments, as described below in greater detail, the first species can be the electrons, and the second species the ions when a plasma is contained within one or more selected ranges of value for the boundary r=Y. In other embodiments, as also described below in greater detail, the first species can be the ions, and the second species the electrons when the plasma is contained in one or more other selected ranges of value for the boundary r=Y.

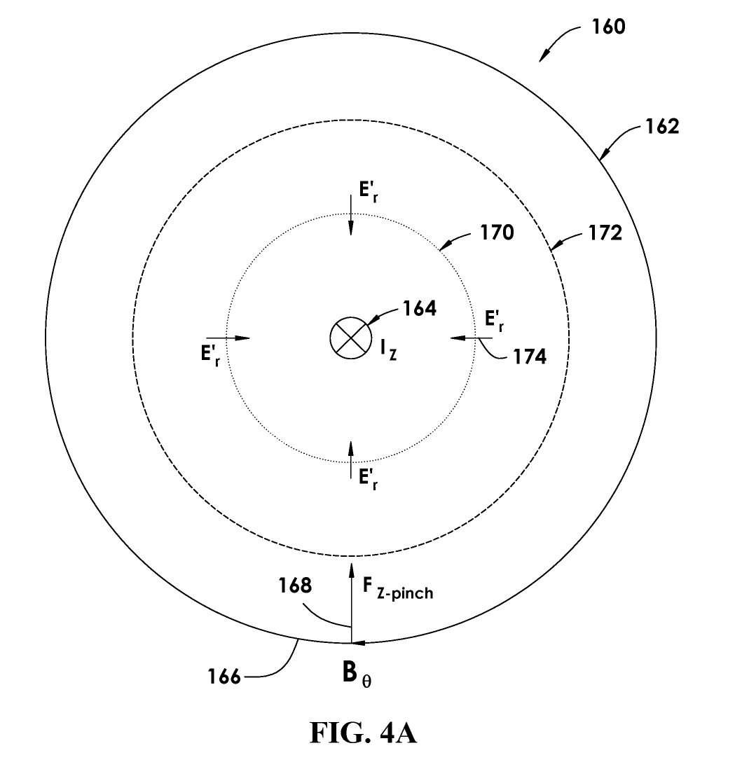

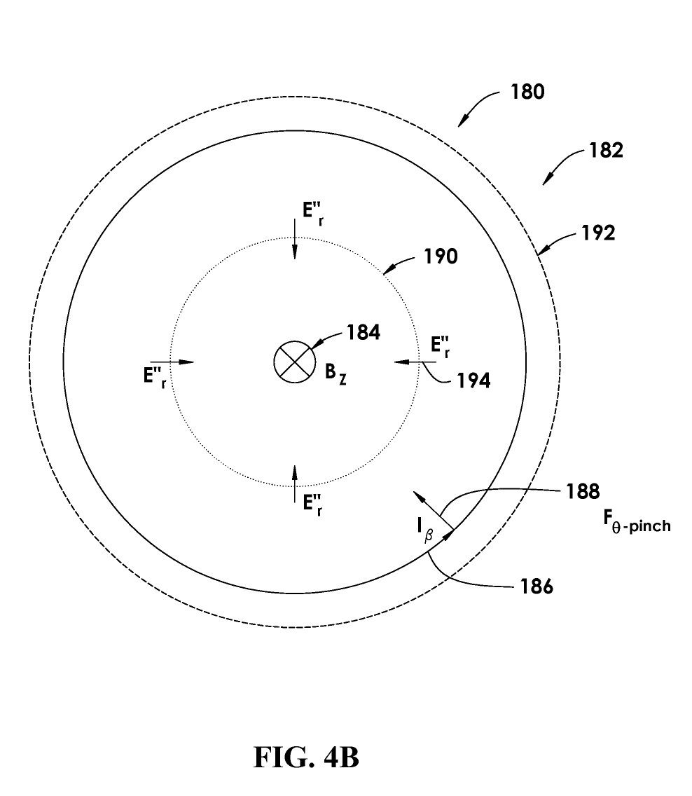

FIGS. 4A and B show two methods of confining a cylindrical geometry plasma by magnetic fields, thereby causing the electron and ion distributions to become different in a manner described above in reference to FIG. 3. FIG. 4A shows one embodiment of a Z-pinch confinement 160, and FIG. 4B shows one embodiment of a theta-pinch confinement 180. Although the Z-pinch and theta-pinch methods are shown separately, it will be understood that these two pinches can be combined to form what is commonly referred to as a screw-pinch.

As shown in FIG. 4A, the Z-pinch 160 can be achieved when an axial current I_{Z} 164 is established in a plasma 172. Such a current can be established in a number of ways, including an example method described below. The axial current I_{Z} 164 causes formation of an azimuthal magnetic field B_{θ} 166 that asserts a radially inward force F_{Z-pinch} 168 on the moving charged particles of the plasma 162.

As described below in greater detail, when the radial dimension of the plasma is selected in certain ranges, motion of one species relative to the other species can be enhanced and thereby be more subject to the magnetic pinching force. Thus, as shown in FIG. 4A, an inner first region 170 of the plasma 162 includes substantially all of the magnetically contained species. In FIG. 4A, the magnetically confined species is depicted as being the electrons. As such, the ions are distributed within a second region 172 that includes and radially extends beyond the first region 170. Such a distribution of the two species can produce a substantial internal radial electric field 174 denoted as E′ᵣ. The radial electric field 174 facilitates containment of the ions substantially within the second region 172. It will be understood that if the ions are made to be magnetically confined within the first region 170, the radial electric field 174 is reversed in direction, and the electron confinement can be facilitated by such an radial electric field

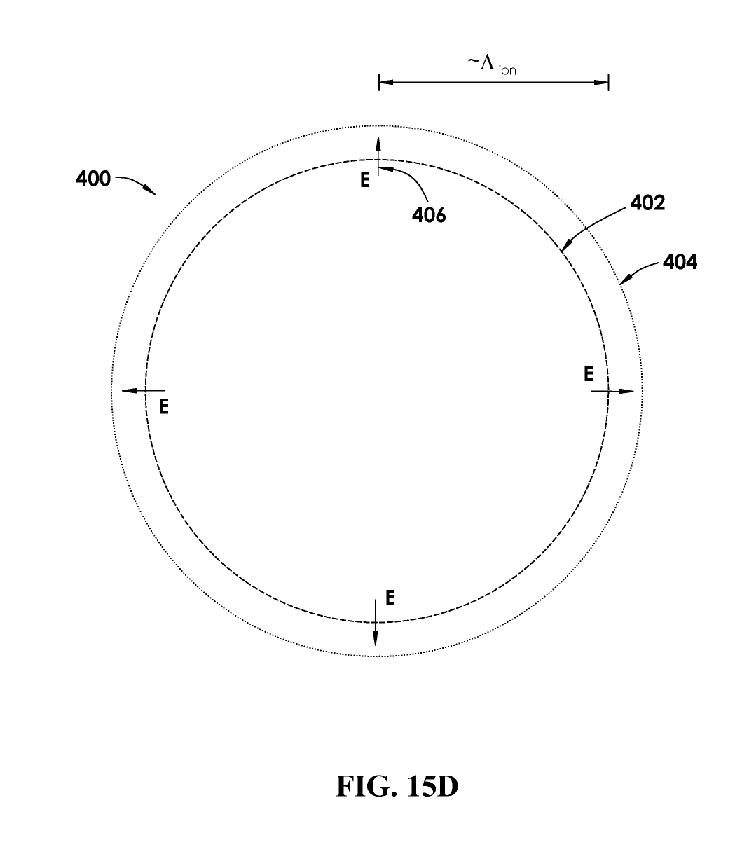

As shown in FIG. 4B, the theta-pinch 180 can be achieved when a steady azimuthal current I_{θ} becomes established in the plasma. The current I_{θ} 186 can be established through plasma relaxation from a high-energy state to the lower(minimum)-energy state as discussed below. The direction of magnetic field B_{Z} 184 in the figure may appear to be inconsistent with the direction of current I_{θ} 186; however, current in external field windings 344 (FIGS. 17A and 17B, discussed below) also contributes to the magnetic field B_{Z} 184. This externally-produced share of the magnetic field is stronger and in the opposite direction from that of the internal, plasma-produced portion of the field. The plasma current I_{θ} 186 thus reduces the magnitude of the total field 184. The axial magnetic field B_{Z} 184 asserts a radially inward force F_{θ-pinch} 188 on the azimuthal current I_{θ} 186 and thereby facilitates containment of the plasma 182.

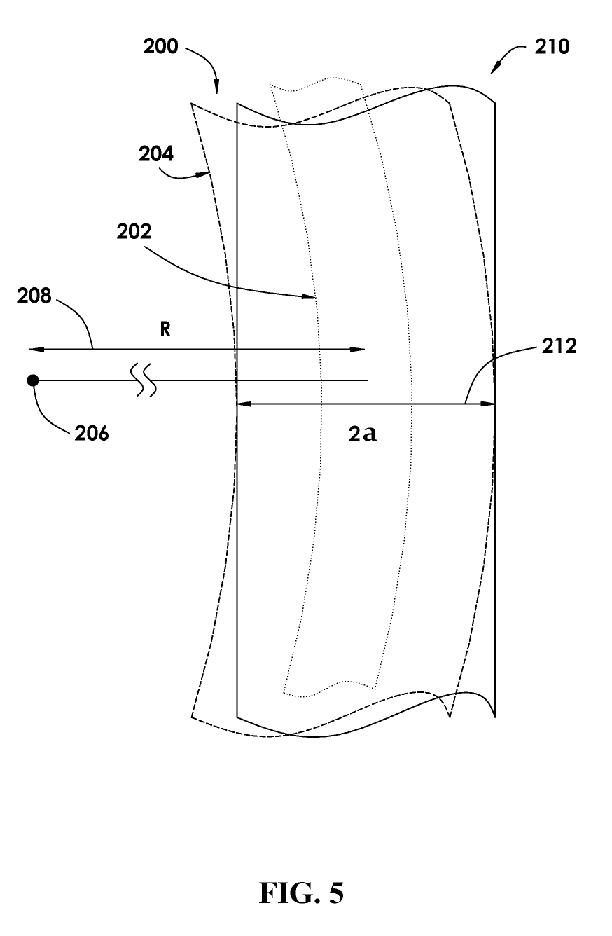

FIG. 5 now shows that a plasma confinement solution described above in the context of cylindrical geometry can be used to approximate a design of a toroidal geometry containment device. A section of a toroidally confined plasma 200 is shown superimposed with a section of a similarly dimensioned (tube dimension) cylindrically confined plasma 210. The toroid 200 is depicted to be centered about a center point 206 such that the center of the toroidal “tube” having a minor radius 212 a is separated from the center point 206 by a distance R (indicated by arrow 208). As will be apparent to those skilled in the art in light of this disclosure, the axial component or direction of the cylindrically confined plasma 210 corresponds to a toroidal component or direction of the toroidally confined plasma 200, with the azimuthal component or direction of the plasma 210 corresponding to a poloidal component or direction of the plasma 200.

One can see that when the major radius R is relatively large compared to the minor radius 212 a, such as in a high aspect ratio (R/a) toroid, a given segment of the toroid geometry can be approximated by the cylindrical geometry. Thus, one can obtain design parameters using a cylindrical geometry, and apply such a solution to designing of a toroidal device. As is known in the art, such a cylindrical approximation provides a good base for a toroidal design. One way to correct for the differences between the toroidal and cylindrical geometries is to provide a corrective external field, often referred to as a vertical field that inhibits the plasma toroid radius R from increasing due to magnetic hoop forces, to confine the plasma.

Thus as shown in FIG. 5, a toroidally confined plasma 200 includes a toroidally shaped first region 202 and a toroidally shaped second region 204 that are arranged with respect to each other in a manner similar to that of a cylindrical plasma. As with the cylindrical plasma, the first region may be defined by electrons in some embodiments, and also by ions in other embodiments.

The foregoing analysis of the cylindrical plasma includes a one-dimensional (r) analysis using the energy variation method. As described above in reference to FIG. 5, such one-dimensional analysis can provide a basis for estimating the design and characterization of a high aspect ratio toroid. A more generalized three-dimensional analysis of, for example, a general toroid or a chamber of any shape, in a similar manner is expected to yield similar results where parts of the electrons and ions separate, thereby causing a substantial radial electric field within the plasma.

One aspect of the present teachings relates to a scale of a contained plasma having a substantial radial electric field therein. Various results of the foregoing energy variational procedure are described in the context of cylindrical symmetry. It will be appreciated, however, that such results can also be manifested in other shapes of contained plasma having a similar scale.

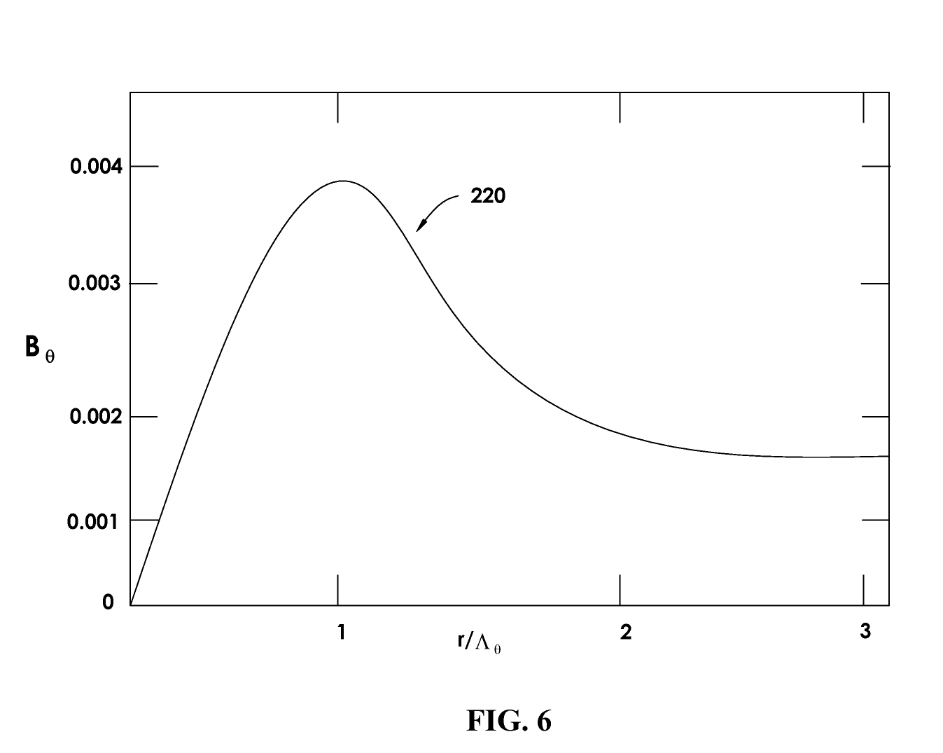

FIGS. 6-10 show various plasma parameters that result from the cylindrically symmetric energy variational analysis for a Z-pinched system with a set of inputs. The plasma is defined as a cylinder having an outer diameter a of approximately three times the skin depth (scale length) Λₑ. With such a selection of the scale of the plasma, example input parameters include N₀=10¹⁹/m³, T₀=5 keV, 1/α=2.51 (thereby defining the magnetic field strength B_{θ}(a) and the axial current I), and 1/β=0 (thereby setting B_{z}(a)=B₀=0). The corresponding electron skin depth parameter Λₑ=(mₑ/μₒN₀ e²)^{1/2} (Equation (10), and depending on the input parameter N₀) is approximately 1.7 mm.

The foregoing input parameters result in a contained plasma where the electrons are pinched by magnetic forces thereby giving rise to electron-ion charge separation. Consequently, the electrons are distributed substantially within the inner region of the cylinder (first region 150 in FIG. 3), and the ions are distributed partially in the first region 150 and partially beyond the boundary (r=Y) of the first region 150. Such a charge separation produces a static electric field that confines the ions. The resulting charge gradient scale length is relatively small—on the order of the electron skin depth as expressed in Equation (10).

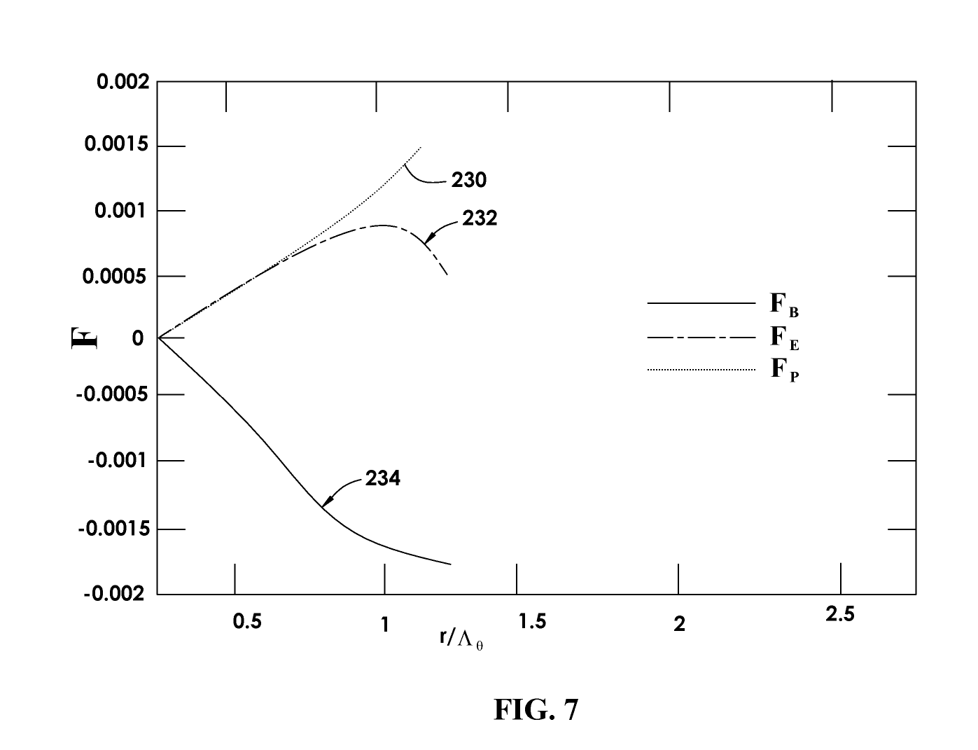

FIG. 6 shows a profile 220 of the azimuthal magnetic field strength B_{θ} as a function of a dimensionless variable r/Λₑ. Such a magnetic field confines the electrons as shown in FIG. 7, where the forces acting on the electrons are shown as a function of r/Λₑ. In the force profile of FIG. 7, a positive value of a force is indicative of a radially outward directionality, and a negative value the opposite. Thus, a kinetic pressure force 230 that tends to make the electron fluid want to expand is directed outward. An electrical force 232 on the electrons is caused by the inwardly directed radial electric field produced in the plasma by the foregoing charge gradient. A magnetic force 234 that confines the electrons is thereby directly inward, and offsets the sum of outwardly directed pressure and electrical forces 230, 232 over much of the electron volume. In the example electron confinement shown in FIG. 7, the pressure and electrical forces 230 and 232 have substantially similar magnitudes over much of the electron volume. In one embodiment shown in FIG. 7, the electron forces profiles do not extend beyond r=Y because there are substantially no electrons beyond that boundary.

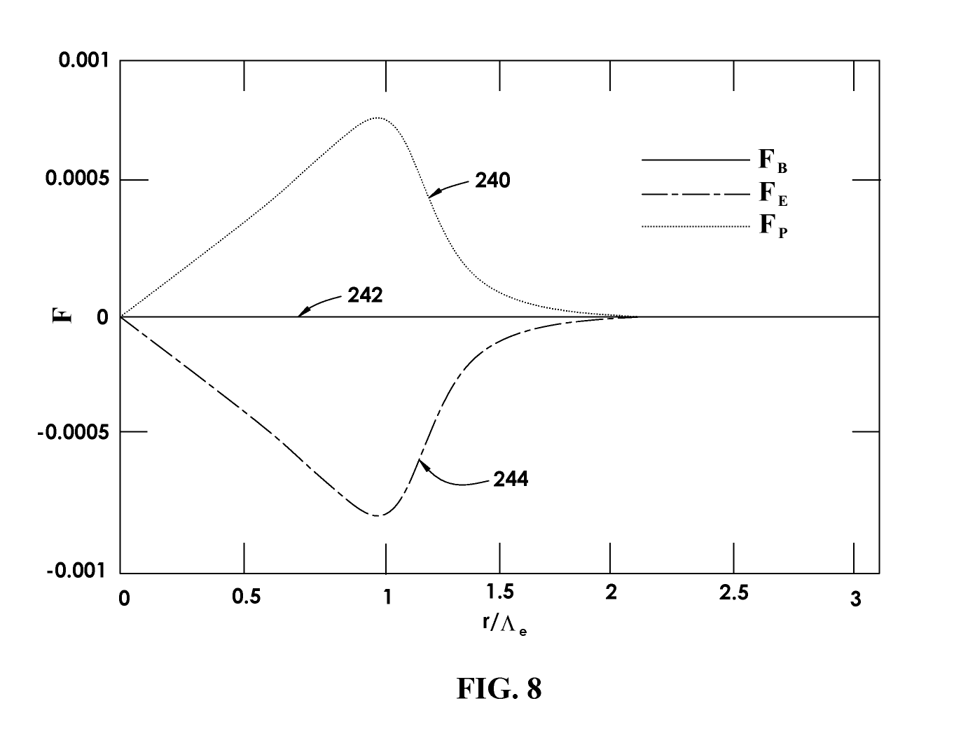

FIG. 8 shows profiles of forces acting on the ions. In electron mode, i.e., where the electrons are carrying the current, a magnetic force 242 on the ions is substantially negligible due to the relatively low velocity of the moving ions. A kinetic pressure force 240 that tends to make the ion fluid want to expand is directed outward. An electrical force 244 on the ions is directed inward, and is caused by the inwardly directed radial electric field produced in the plasma by the foregoing charge gradient. One can see that the electrical force 244 is significant and generally offsets the pressure force 240. Thus, the electric field produced from the charge separation is the primary ion confining force.

It will be appreciated that while the magnetic field provides an initial confinement mechanism for the plasma, the internally-produced radial electric field adds to a stable plasma equilibrium. The force profiles shown in FIGS. 7 and 8 and the resulting steady-state equilibrium of the plasma underscore the importance of the electric field. Such a stable equilibrium state facilitated by the radial electric field does not appear if the plasma is quasi-neutral. Hence, the importance of not making the quasi-neutrality assumption in designing a plasma containment device is demonstrated.

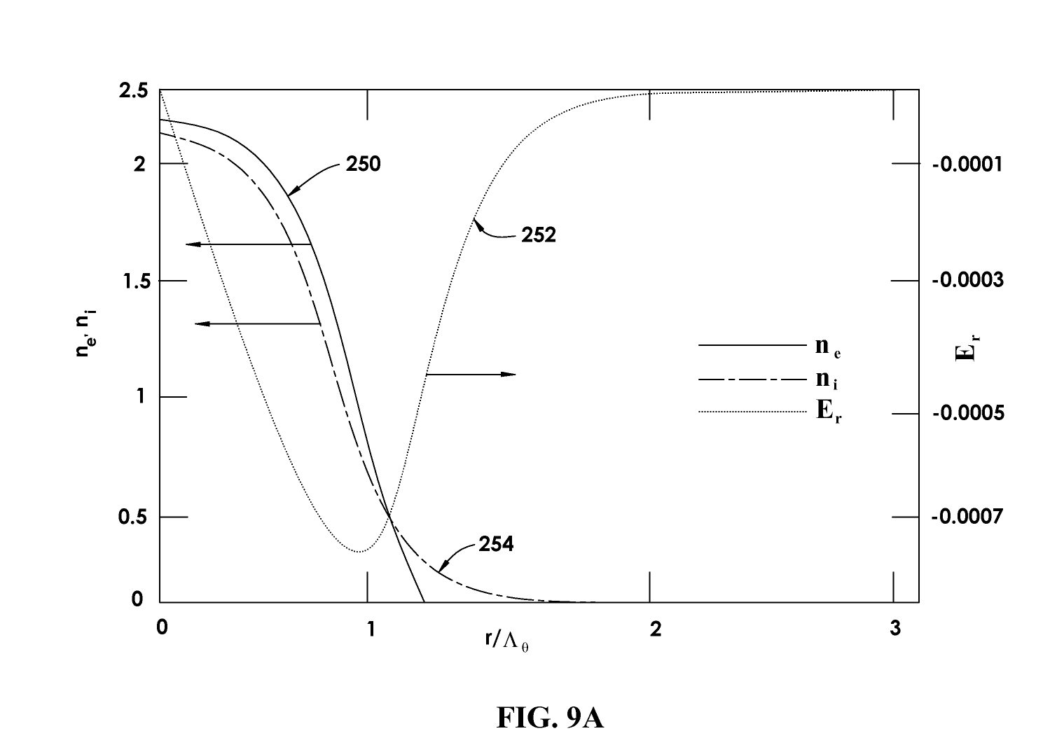

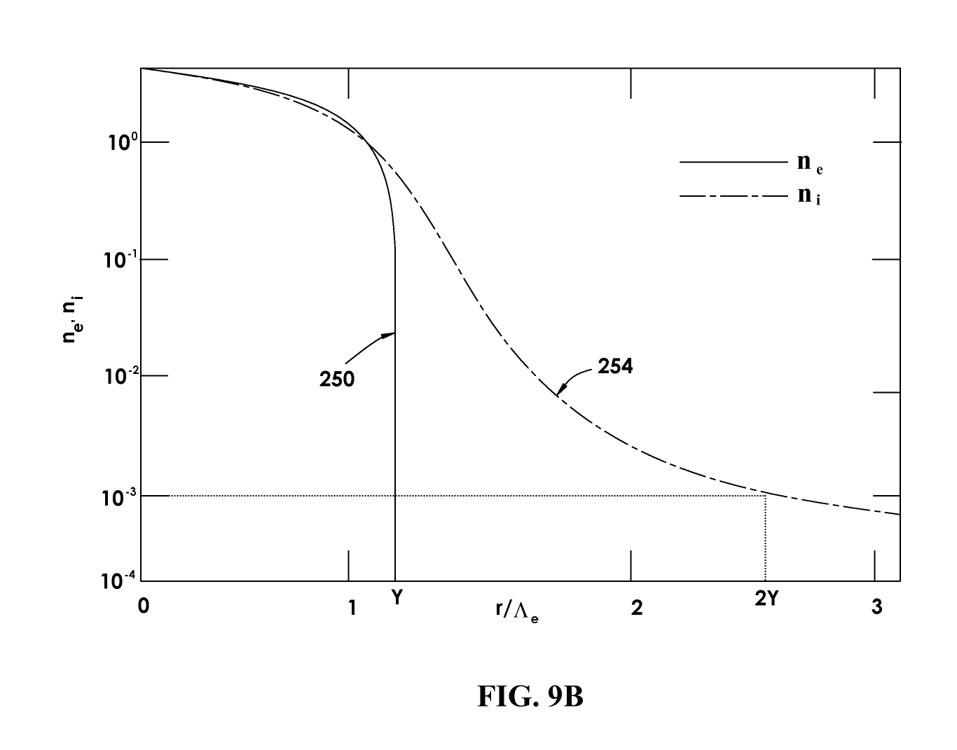

FIG. 9A now shows an electron distribution 250 and an ion distribution 254 that give rise to an electric field profile 252. The three curves 250, 252, and 254 are shown as functions of a dimensionless variable r/Λₑ. The vertical scale for the electron distributions 250 and ion distributions 254 is in terms of the average density value N₀. The electric field profile 252 gives rise to the electrical force profiles described above in reference to FIGS. 7 and 8. As the electron distribution 250 shows, the electrons are distributed substantially within the boundary Y at approximately 1.2Λₑ. As defined in Equation (10), the value of Λₑ=(mₑ/μₒN₀ e²)^{1/2} is approximately 1.7 mm when N₀=10¹⁹/m³. Thus, the value of the electron boundary Y for the example plasma of FIG. 9A is approximately 2.04 mm.

As shown in FIG. 9A, the electron and ion distributions overlap over at least a portion of the plasma about the axis. As further shown in FIG. 9A, the electrons are substantially confined to a restricted volume defined by the electron boundary Y. Thus, such a restricted volume can be characterized by a volume scale length such as the electron skin depth Λₑ.

As further shown in FIG. 9A, the ion distribution 254 extends beyond the boundary Y. Beyond the Y boundary, the ion fluid can be characterized as satisfying single fluid equations that can easily be obtained by modifying the set of equations described above. One way to obtain a substantially complete ion distribution and its associated plasma parameter(s) is to match the two sets of equations (r<Y and r>Y) at the boundary Y by adjusting input parameters until the dependent variables and their derivatives are substantially continuous at Y.

One aspect of the present teachings relates to a plasma system having a bulk separation of charges, as shown by the electron and ion distributions 250 and 254, thereby causing formation of the radially directed electric field profile 252 that substantially overlaps with the plasma volume. Such a coverage of the produced radial electric field can be achieved in contained plasma systems where the boundary Y for electrons has a dimension on the order of the electron scale length Λₑ.

For a system to lie within an energy well sufficiently deep to provide a robust confinement for one embodiment, the cylinder radius can lie within a range near the value of the electron scale length (skin depth) Λₑ. In the example embodiment described above in reference to FIGS. 6-9, Y≈1.2Λₑ, and the electric field extends over a substantial portion of the plasma.

A relatively large radius configuration (e.g., Y=6Λₑ) can result in a substantial electric field being produced near the outer region of the plasma cylinder. An energy well associated with such a configuration can be relatively shallow when compared to the Y≈1.2Λₑ case. Also, a relatively small radius configuration (e.g., Y=0.3Λₑ) can result in confinement being lost.

Thus in one embodiment, a plasma confinement that is facilitated by the radial electric field has a value of Y that is in a range of approximately 1 to 2 times the electron scale length Λₑ. In one embodiment, a value of Y around 1.2Λₑ appears to provide a near optimal confinement condition. For a plasma with N₀=10¹⁹/m³ (as with the example plasma of FIGS. 6-9), Λₑ=1.7 mm, and Y=(1.2)(1.7)≈2.04 mm. Since a=3Λₑ for the example plasma, the outer radius of the contained plasma is approximately 5.1 mm. One can see that such a compact dimension of a stable, contained plasma can be used in a number of applications, some of which are described below in greater detail.

The plasma is contained such that energy and/or particle loss(es) from the plasma to a wall defining a containment volume is reduced. One way to achieve such energy/particle loss reduction is to reduce the number of plasma particles coming into contact with the wall. As shown in FIG. 9B, where the electron and ion distributions 250 and 254 are plotted on a logarithmic scale, the ion number density 254 reaches a value of approximately 0.001 N₀ when r/Λₑ is approximately twice the value of Y. Thus for an embodiment where Y=1.2Λₑ≈2.04 mm, the ion number density reaches approximately 0.1% of the average density value N₀ at r≈(2.04)(2)=4.1 mm

As described above, for a plasma containment design where a=3Λₑ, the outer radius a is approximately 5.1 mm for the Y=1.2Λₑ case. For such a system, a wall can be positioned at a location r>5.1 mm and still allow construction of a relatively small containment device. Moreover, the ion number density at r>5.1 mm (3Λₑ) is substantially lower than the 0.1% level described above. Thus, the number of ions coming into contact with the wall at r>5.1 mm and transferring energy thereto and/or interacting therewith is reduced even more.

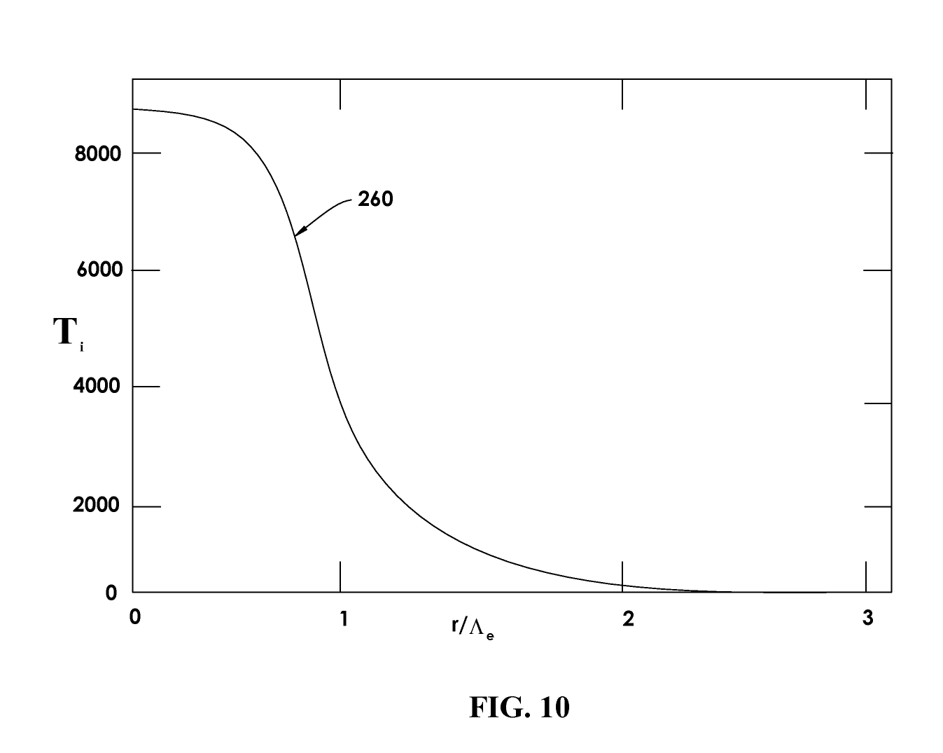

FIG. 10 shows a plasma temperature profile 260 as a function of r/Λₑ for the example plasma described above in reference to FIGS. 6-9. One can see that the temperature is reduced substantially at 3Λₑ (5.2 mm). The temperature is even lower for the region r>3Λₑ. Thus, heat transfer from the plasma to the wall located at r>3Λₑ is reduced, since the plasma particles that come into contact with the wall have substantially low kinetic energies when compared to the inner portion of the plasma.

The example plasma described above in reference to FIGS. 6-10 advantageously includes the radial electric field. Such a plasma includes electrons distributed substantially within a boundary Y that is in a range of approximately 1-2Λₑ so as to allow the electric field to cover a substantial portion of the plasma volume. Such a significant presence of the electric field facilitates a robust containment of the plasma at a scale on the order of the electron scale length (skin depth). Investigation of such a plasma system shows that such features of the contained plasma at such a scale hold when the input parameters are varied significantly. As an example, similar advantageous electric field facilitated confinement holds within a factor of approximately 2 when the average number density N₀ changes by a factor of approximately 10 and when the input temperature value T₀ changes by a factor of approximately 30. Thus, design of a plasma containment having a dimension on the order of electron scale length can be made relatively flexible.

The present disclosure reveals substantial electric fields due to excess electrons in the r<Y region and ions being substantially the only species in the r>Y region. As described above, numerical solutions can be obtained by solving Equations (11A)-(11P) for r<Y and substituting Y for a in the boundary conditions. One can solve the modified set (for ions) for r>Y and replacing 0 by Y in the boundary conditions and then matching the solutions of the two sets at r=Y. In one embodiment, the number density of the magnetically bound species becomes substantially zero at r=Y.

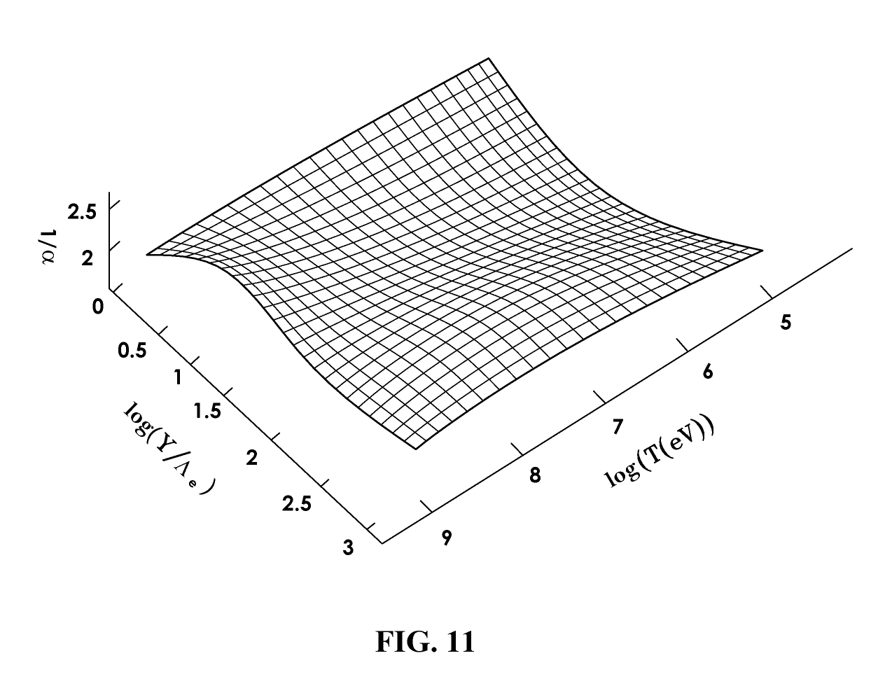

In one embodiment, accomplishing such a matching process can place an additional restriction on the input or control parameters that can be expressed in terms of 1/α and 1/β. For example, in the cylindrical coordinate treatment of the Z-pinch embodiment, 1/α, which can be obtained from N₀, T₀, and B₀, is approximately 2 (for typical fusion plasma parameter values). A more precise value of 1/α can be expressed as a slowly varying function of T₀ and n₀. For the example cylindrical geometry, an approximate value can be obtained from an example contour plot of 1/α as a function of Y/Λₑ and temperature T, such as that of FIG. 11. For a theta-pinch, screw-pinch, ions moving, other geometries, or combinations thereof, the appropriate restriction can be obtained either experimentally or by solving the equations similar to Equations (11A)-(11P) and the appropriate modified set for r>Y. In one embodiment, the number density of the current carrying species approaches approximately zero at the boundary r=Y. In one embodiment where both species can carry substantial current, similar method can be applied to obtain a solution.

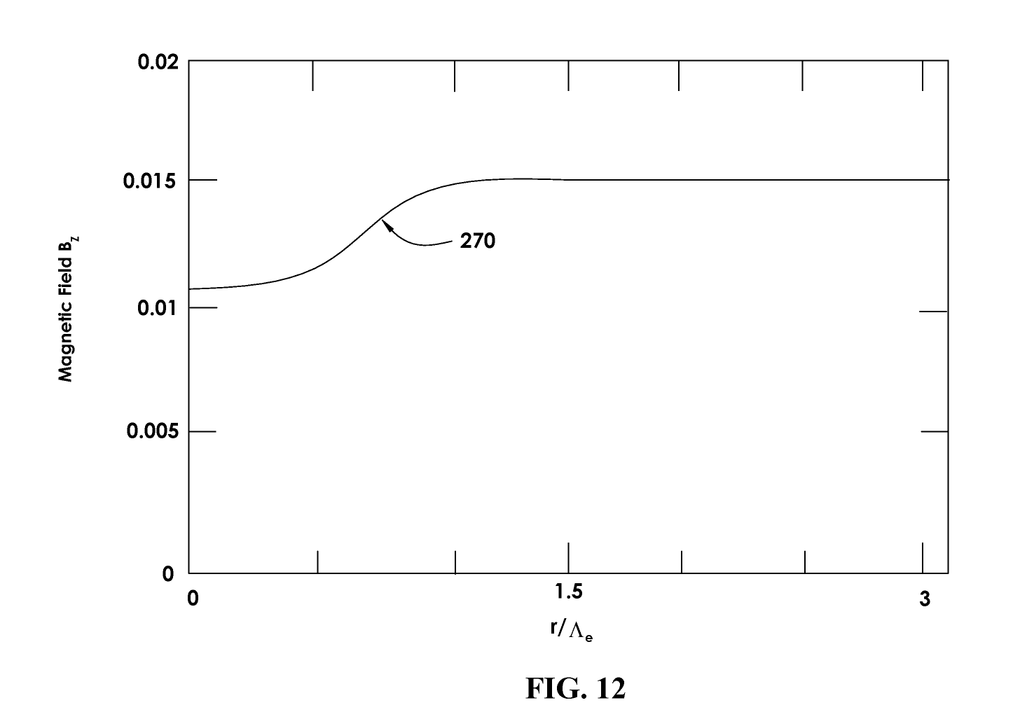

The example plasma described above in reference to FIGS. 6-10 is Z-pinched. Similar radial electric field effects can also arise when a plasma is theta-pinched. FIGS. 12-14 show an example result of the energy variational method described above with regard to a theta pinch.

For the theta-pinch example, an outer diameter a of approximately 3Λₑ is used. Furthermore, input parameters N₀=10¹⁹/m³, T₀=10⁴ keV, 1/α=0, and 1/β=20.5 are used. The corresponding electron scale length Λₑ=(mₑ/μₒN₀ e²)^{1/2} is approximately 1.7 mm.

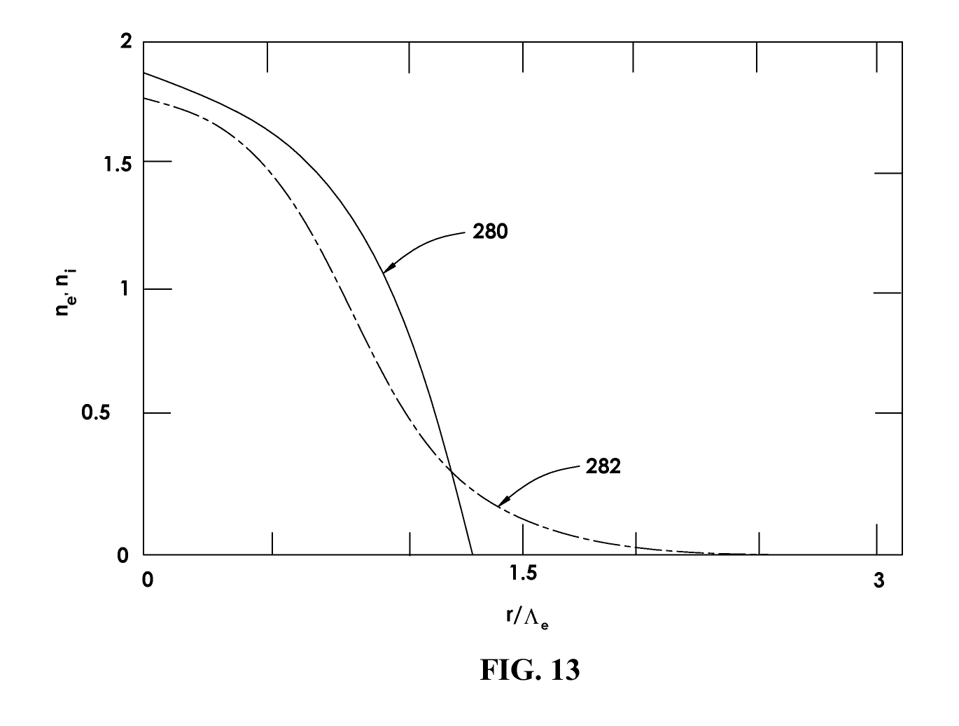

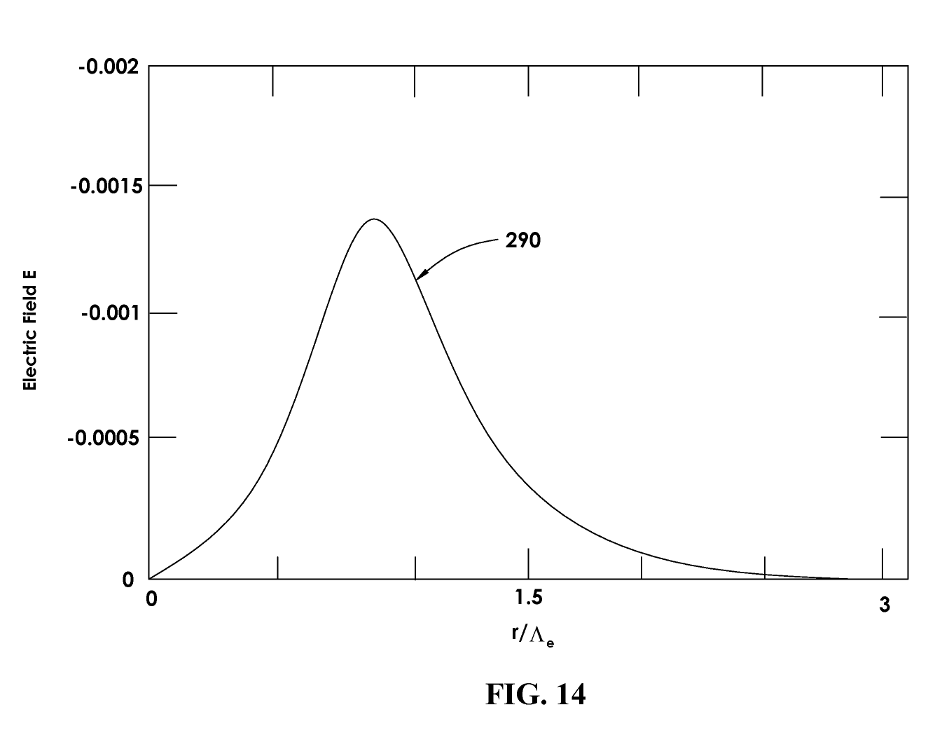

Based on the foregoing example inputs, FIG. 12 shows an axial magnetic field profile 270 as a function of distance from the Z axis. Such a magnetic field theta-pinch can confine the plasma such that an electron distribution 280 and an ion distribution 282 are formed as shown in FIG. 13. Separation of charges due to such distributions can cause a substantial radial electric field profile 290 as shown in FIG. 14.

The foregoing example theta-pinch confinement results in the value of Y being approximately 2.04 mm. Thus, a theta-pinched plasma with a confinement dimension on the order of the electron scale length Λₑ can provide the various advantageous features described above in reference to the Z-pinched plasma system.

As previously described, a screw-pinch can be achieved by a combination of Z and theta pinches. Thus, an energy variational analysis similar to the foregoing can be performed with 1/α≠0 and 1 /β≠0 to yield similar results where a substantial radial electric field is produced by separation of charges. Furthermore, a screw-pinched plasma with a confinement dimension on the order of the electron scale length Λₑ can provide similar advantageous features described above in reference to Z and theta pinched plasma systems. Screw-pinch magnetically confined plasmas are generally regarded as more stable than simple Z- or theta-pinches. It is expected that screw-pinch embodiments of the present teachings will share the various features disclosed herein.

As also described, magnetically confining a plasma in a dimension on the order of the plasma's electron scale length results in separation of charges, thereby inducing a substantial radial electric field over a substantial portion of the plasma volume. Such an electric field can be characterized so as to correspond to a depth of an energy well associated with a stable equilibrium. Moreover, the energy well depth is expected to be relatively deep when the electron fluid radius Y is in a range of approximately 1-2Λₑ. Such relatively deep energy well of the equilibrium provides a relatively stable confined plasma. Such stability of a confined plasma at a value of Y of approximately 1-2Λₑ, however, does not preclude a possibility that magnetic confinement at larger values of Y can have its stability facilitated significantly by the radial electric field.

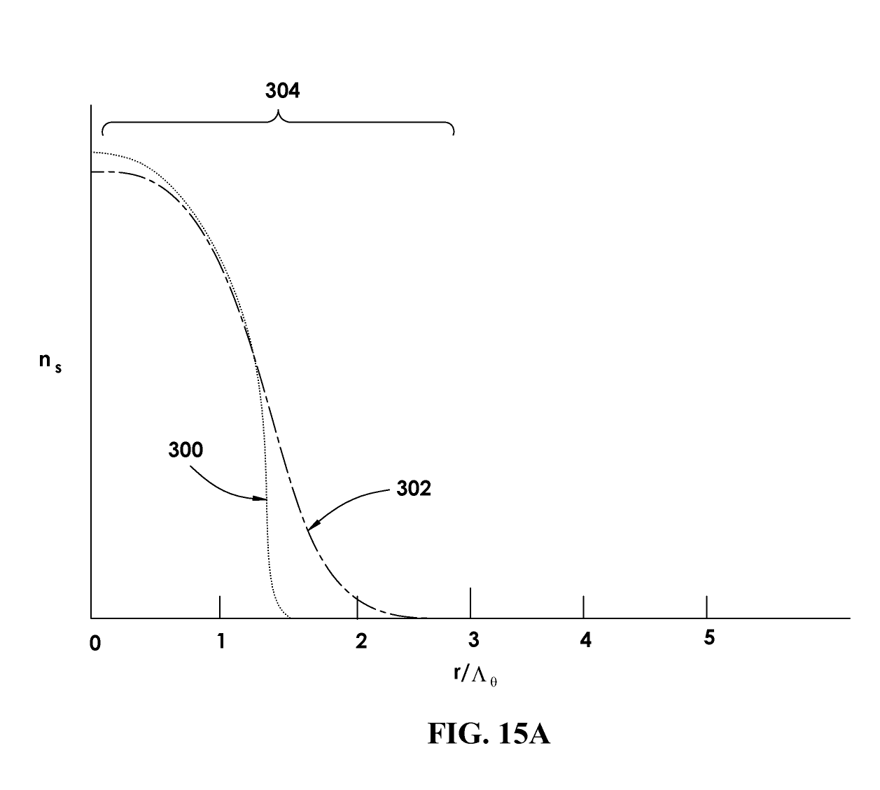

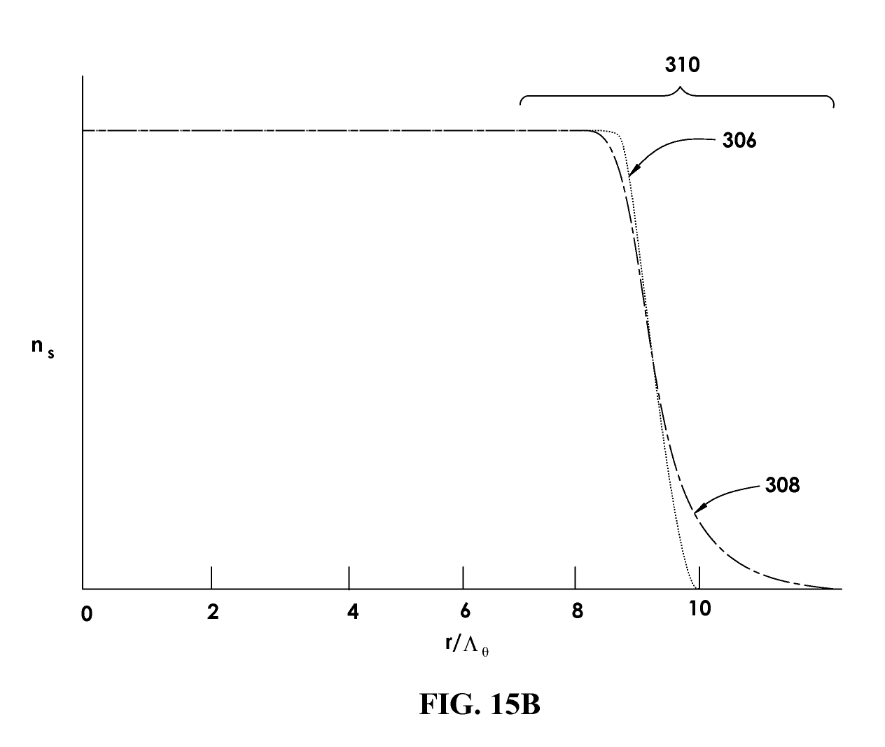

One aspect of the present teachings relates to a magnetically confined and relatively stable equilibriated plasma at different dimensional scales. FIGS. 15A-C show electron and ion distributions for different plasma sizes. While the larger sized plasma systems may not yield equilibria that are as stable as the case where Y=1-2Λₑ, such equilibria may nevertheless have sufficient stabilities that are facilitated by the electric field.

FIG. 15A shows a first set of particle densities as a function of the dimensionless variable r/Λₑ. Curves 300 and 302 represent example electron and ion distributions. The electron distribution 300 is depicted as being substantially bounded at Y≈1.5Λₑ, and is thereby similar to the example plasma described above in reference to FIG. 9A. A resulting radial electric field (indicated as a bracket 304) covers a substantial portion of the plasma.

FIG. 15B shows a second set of particle densities where an electron density distribution 306 is substantially bounded at an example value of Y≈10Λₑ. An ion density distribution 308 is shown to extend beyond the boundary Y, thereby inducing a radial electric field that influences a region 310 near the outer boundary of the plasma

FIG. 15C shows a third set of particle densities where an electron density distribution 312 is substantially bounded at an example value of Y≈40Λₑ. An ion density distribution 314 is shown to extend beyond the boundary Y, thereby inducing a radial electric field that influences a region 316 near the outer boundary of the plasma.

In various plasma embodiments, the electric field coverage scales (304, 310, 316) are generally similar, and can be on the order of few electron scale lengths. Thus, one way to characterize a role of the radial electric field in the stability of the plasma is to consider the electric field as a layer formed near the surface of the plasma volume. In systems where a plasma volume dimension (e.g., radius a in cylindrical systems) is on the order of the E-field layer “thickness” (such as the system of FIG. 15A), the influence of the radial electric field is substantial with respect to the overall plasma. Consequently, an energy stability facilitated by the radial electric field can be more pronounced in such systems.

In systems where a plasma volume dimension is substantially larger than the E-field layer “thickness” (such as the systems of FIGS. 15B and C), the influence of the radial electric field may not be as substantial when compared to systems such as that of FIG. 15A. Consequently, radial electric fields can provide significant contributions to energy stability; however, such contributions are typically not expected to be as pronounced as that of a smaller system.

One aspect of the present teachings relates to a plasma having a substantially larger scale length (skin depth) than that of plasmas where the radial electric field is on the order of an electron scale length (electron skin depth). FIG. 15D shows an example plasma 400 having an ion distribution bounded at an inner boundary 402 and an electron distribution bounded at an outer boundary 404, thereby inducing an radial electric field 406 that points radially outward. One can see that in such a plasma, roles of the electrons and ions are reversed from the electron mode of operation.

In such a role-reversed plasma, ions act as charge carriers, thereby being subject to magnetic confinement. The value of a for the ions-moving plasma would be many times that for the electrons-moving plasma because of the much larger ion skin depth Λᵢₒₙ=(mᵢₒₙ/μₒN₀ e²)^{1/2}. For plasmas having a similar average density value, the ratio of Λᵢₒₙ/Λₑ=(mᵢₒₙ/mₑ)^{1/2}. For deuterium, the ratio Λᵢₒₙ/Λₑ is approximately 61. Thus, a plasma having moving ions would have a volume of approximately 61²=3700 times that of the similar electrons-moving plasma, all else being substantially the same. The energy variational method described herein can be modified readily for analysis, and a resulting plasma system likely would be sufficiently large to allow power production.

As described above in connection with FIGS. 1-15, the radial electric field can form in a plasma having a wide range of volume scale length. For a plasma where the electrons are magnetically confined, the volume scale length can be represented by the electron confinement dimension Y. In one embodiment, the volume scale length can range from approximately 1Λₑ to approximately 1000Λₑ. In one embodiment, the volume scale length can range from approximately 1Λₑ to approximately 100Λₑ. In one embodiment, the volume scale length can range from approximately 1Λₑ to approximately 60Λₑ. In one embodiment, the volume scale length can range from approximately 1Λₑ to approximately 40Λₑ. In one embodiment, the volume scale length can range from approximately 1Λₑ to approximately 10Λₑ. In one embodiment, the volume scale length can range from approximately 1Λₑ to approximately 2Λₑ. Similar volume scale length characterization can be applied to the plasma where the ions are confined.

As described above in connection with FIGS. 1-15, the radial electric field formed in the plasma facilitates formation of a stable plasma state. In particular, the radial electric field is radially directed. Radial electric fields are known to exist in large systems such as tokamaks. However, such radial fields are not due to the significant separation of the charges. Rather, such radial fields are the result of imbalances in the ion Lorentz and ion pressure forces, and the field magnitudes appear to be significantly smaller than the magnitudes of the static electric field (by charge separation) of the present invention.

As described above in connection with FIGS. 1-15, radial electric field—facilitated stable plasma can be formed by magnetic confinement of electrons or ions. In such configurations, the magnetically confined particles act as charge carriers. Thus, when electrons act as charge carriers, electrons are magnetically confined; when ions act as charge carriers, ions are magnetically confined.

Being a charge carrier in the plasma can be characterized in different ways. One way is to say that charge carriers cause a current in the plasma. Another way is to say that charge carriers undergo a bulk motion in the plasma. Yet another way is to say that charge carriers flow in the plasma.

In one embodiment, both the electrons and the ions can act as charge carriers. That is, both the electrons and the ions can contribute to the current, undergo bulk motions, and flow in the plasma. A difference in the degrees of a current-producing characteristic of the two species can give rise to one species being confined magnetically more than the other. Such a difference in the magnetic confinements of the two species can produce a charge separation that causes formation of a radial electric field in the plasma.

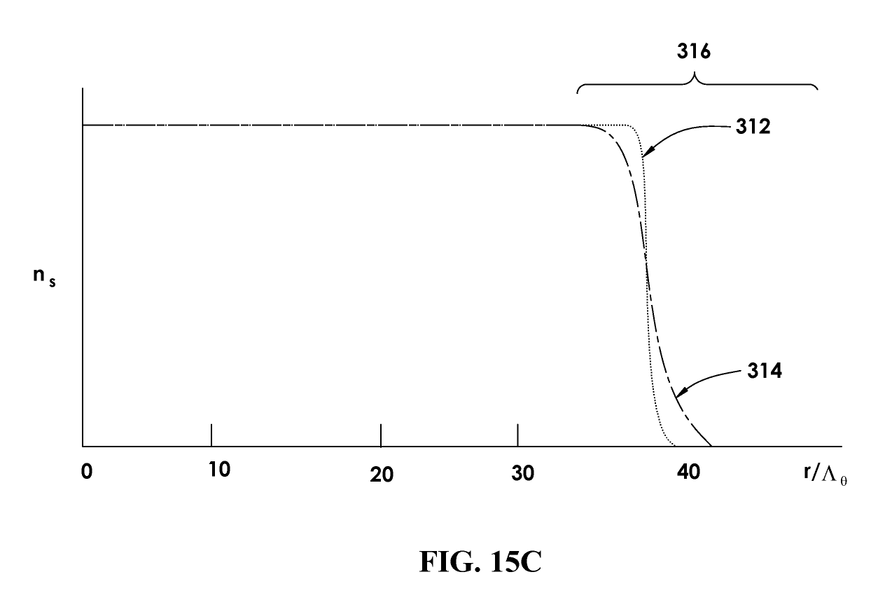

FIGS. 16 and 17 now show simplified diagrams of toroidal vacuum devices 322 that can magnetically contain a plasma having the substantial radial electric field therein. FIGS. 16A and B show one embodiment of a containment apparatus 320 having a toroidal vacuum device 322 magnetically coupled to a primary winding 324 via a transformer core 326. The containment apparatus 320 may be a z-pinch device.

The toroidal charge carriers in the containment apparatus 320 act as a secondary winding on the transformer core 326, such that a primary current i₁(t) established in the primary winding 324 from a power supply 334 produces a time-varying axial electric field 321 E_{T} that inductively drives a first particle current i₂(t) 332 within the containment apparatus 320.

Such a toroidal first particle current 332 (an axial current in the cylindrical approximation) confines the plasma as described above in reference to FIG. 4A. Appropriately selected dimension of the containment apparatus 320 and appropriately selected parameters for plasma therein results in the separation of a first particle density distribution 330 from a second particle density distribution 328, thereby inducing the substantial radial electric field.

In one embodiment, the first particle density distribution 328 is an electron density distribution and the second particle density distribution 330 is an ion density distribution. In an alternate embodiment, the first particle density distribution 328 is an ion density distribution and the second particle density distribution 330 is an electron density distribution.

FIGS. 17A and 17B show a simplified theta-pinch device 340 having a containment section 342 with a winding 344 thereabout. A current i(t) can be generated by a power supply 346 and be passed through the winding 344, thereby forming an axial magnetic field B_{Z} 352 (toroidal field in a toroidal system). As described above in reference to FIG. 4B, such a magnetic field can confine the plasma via a theta-pinch. Appropriately selected dimension of the confinement section 342 and appropriately selected parameters for plasma therein can result in the separation of an electron density distribution 350 from an ion density distribution 348, thereby inducing the substantial radial electric field. The total magnetic field B_{Z} 352 is due to the sum of the current in the plasma I_{θ} 186 (FIG. 4B) and the current in the external winding 344 (FIG. 17B). These currents are oppositely directed with the field contribution due to the winding 344 dominating.

As previously described, the Z- and theta-pinches can be combined to yield a screw-pinch. Thus, the Z and theta pinch devices of FIGS. 16 and 17 can be combined to yield a screw-pinch containment apparatus 320. Furthermore, such confinement methods and various concepts disclosed herein can be implemented in any containment devices having a confinement section that can be approximated by a cylindrical geometry.

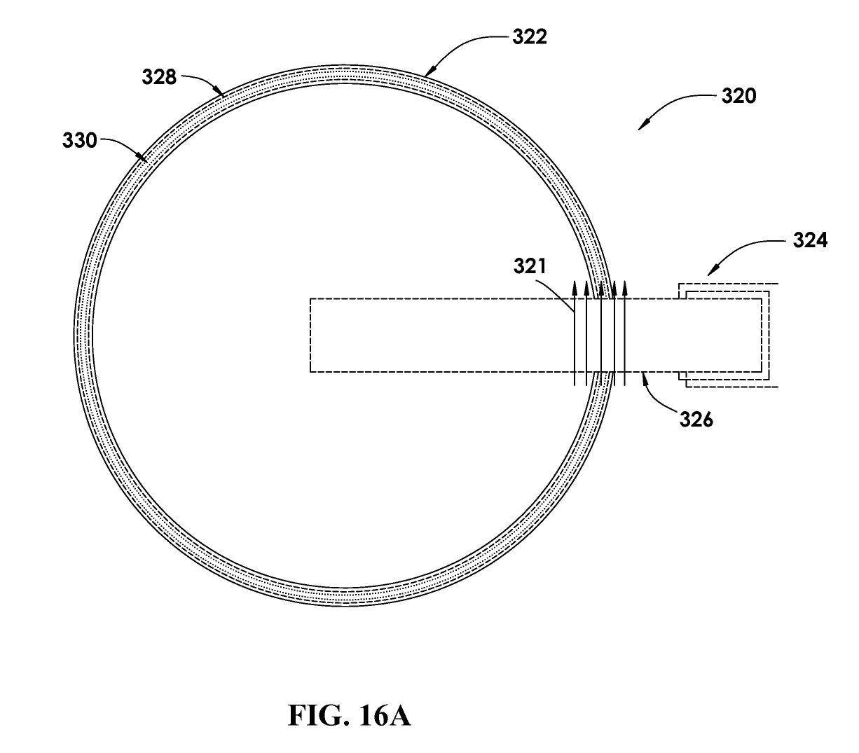

FIG. 18 shows an embodiment of a containment apparatus 320. The containment apparatus 320 may correspond to the containment apparatus 320 of FIGS. 16A and 16B and the containment section 342 of FIG. 17. The description of the containment apparatus 320 refers to elements of FIGS. 1-17, like numbers referring to like elements. The containment apparatus 320 comprises a toroidal vacuum device 322 that is a torus in shape and is composed of an insulating material such as pyrex in order that an externally produced electric field can penetrate through the wall to a plasma disposed in the toroidal vacuum device 322. Alternatively, the toroidal vacuum device 322 may be composed generally of a conducting material such as stainless steel for improved mechanical strength.

The toroidal vacuum device 322 has a major radius 208 R from a center point 209 to a toroidal axis 213. The toroidal vacuum device 322 further has a minor radius 212 a from the toroidal axis 213 to an inner wall of the toroidal vacuum device 322.

The containment apparatus 320 may have an opening 393. The opening 393 may be connected to a gas device 327 comprising a vacuum pump 394, a gas supply 396, a vacuum valve 395, and a gas valve 397. The vacuum valve 395 may control the connection of the vacuum pump 394 to the containment apparatus 320. The gas valve 397 may control the connection of the gas supply 396 to the containment apparatus 320.

In one embodiment, the vacuum valve 395 is opened and the vacuum pump 394 evacuates the containment apparatus 320. The vacuum valve 395 may be closed and the gas valve 397 opened to admit a metered amount of gas 391 into the containment apparatus 320. The gas valve 397 may be closed to trap the gas 391 within the containment apparatus 320.

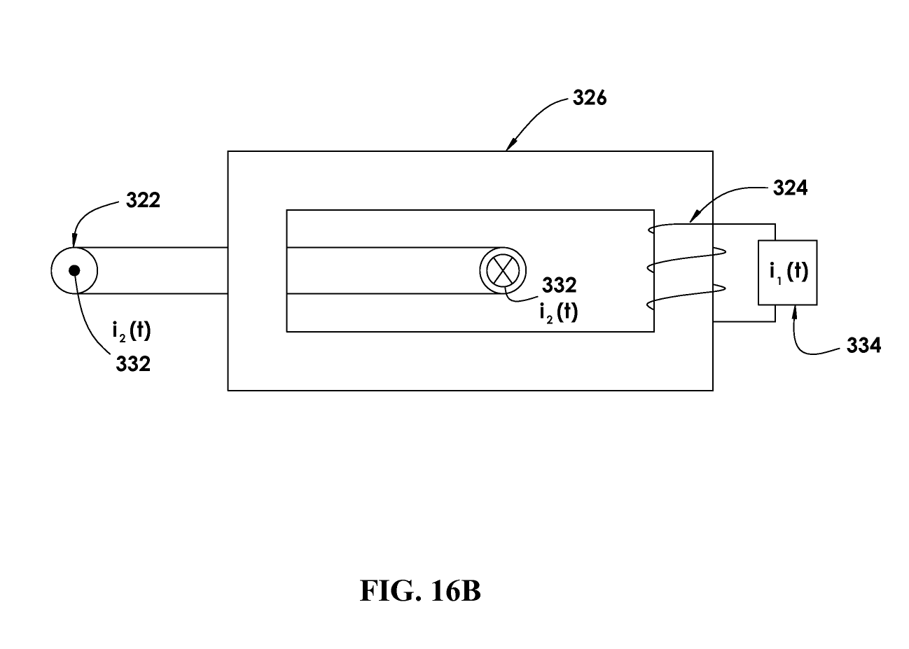

FIG. 19 is a top view drawing of one embodiment of the containment apparatus 320. The description of the containment apparatus 320 refers to elements of FIGS. 1-18, like numbers referring to like elements. In particular, the containment apparatus 320 includes the toroidal vacuum device 322 and the gas device 327 of FIG. 18 and the transformer 326 of FIG. 16A.

The transformer 326 may inductively drive a first particle current in the plasma by generating an axial electric field 321 Eₜ along the toroidal axis 213 as described in FIG. 16A. The axial electric field 321 may be generated through time-changing magnetic fields of the transformer 326. Alternatively, a solenoid or other apparatus may supply the time-changing magnetic field. In order for the axial electric field 321 Eₜ to appear within the plasma itself rather than in a conducting wall of the toroidal vacuum device 322, insulating breaks including poloidally-oriented breaks 401 and toroidally-oriented breaks may be provided.

The containment apparatus 320 further includes an ionizing device 321. In one embodiment, the ionizing device 341 ionizes the gas 391 using magnetic induction. A voltage may be applied between a parallel plate capacitor, generating a toroidally-oriented electric field. The voltage may be in the range of 2 to 20 V. The toroidally-oriented electric field accelerates electrons. The accelerated electrons may strike neutral gas atoms, ionizing the gas 391.

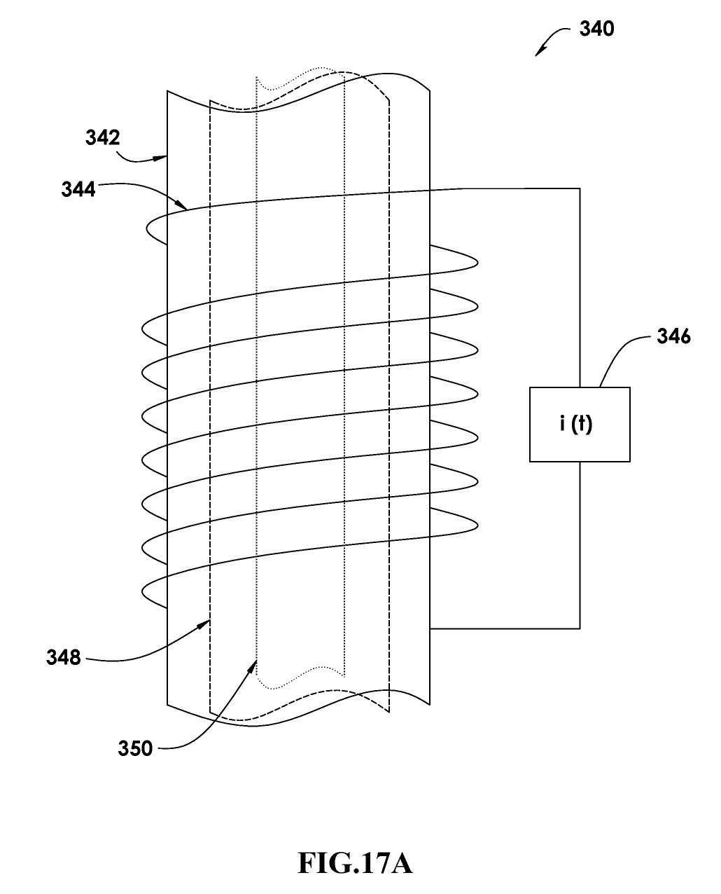

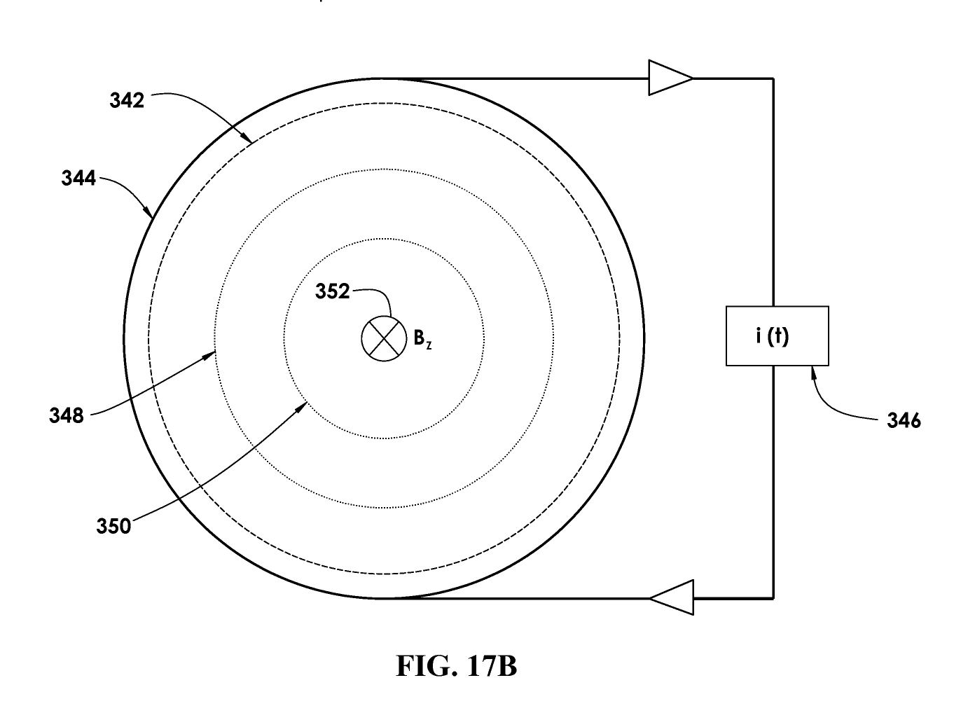

FIG. 20 is a side view drawing of one embodiment of the toroidal vacuum device 322. The toroidal vacuum device 322 may be the toroidal vacuum device 322 of FIG. 19 along the A-A view line. FIG. 21 is a cut-away drawing of one embodiment of the toroidal vacuum device 322 of FIGS. 19 and 20. The toroidal vacuum device 322 may be the toroidal vacuum device 322 of FIG. 19 along the B-B view line.

The poloidally-oriented breaks 401 keep toroidal current from flowing in the wall of the toroidal vacuum device 322 whereas the toroidally oriented breaks 403 stop poloidal current in a wall of the toroidal vacuum device 322. The poloidally-oriented breaks 401 and toroidally-oriented breaks 403 separate the toroidal vacuum device 322 into four conducting pieces so that there is no complete conducting path for either poloidal or toroidal current to flow within the wall of the toroidal vacuum device 322. Under some circumstances, if the insulting breaks 401, 403 are not present, the transformer generated magnetic fields may only drive currents within the wall of the toroidal vacuum device 322 rather than in the plasma contained therein.

In an alternate embodiment, the toroidal vacuum device 322 comprises a conducting material, but has no insulating breaks. Under some circumstances, induction of electric fields in this embodiment, though somewhat less efficient, is not reduced sufficiently to hamper the operation of the containment apparatus 320. An advantage of this embodiment is that a conducting wall with complete toroidal and poloidal current paths may tend to suppress certain instabilities.

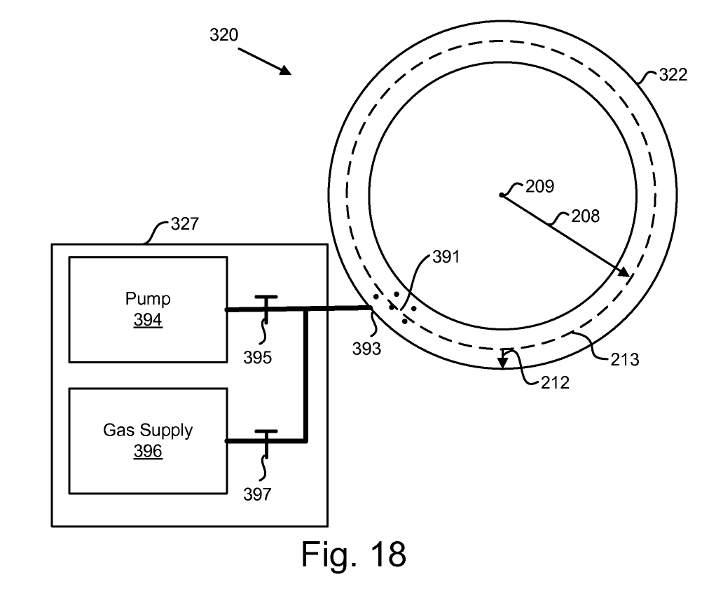

FIG. 22 is a side view drawing of one embodiment of the containment apparatus 320. The containment apparatus 320 is the containment apparatus of FIG. 19. The description of the containment apparatus 320 refers to elements of FIGS. 1-23, like numbers referring to like elements. For simplicity, some previously described elements are not depicted.

Field coils 414 are depicted wound around a portion of the toroidal vacuum device 322. The field coils 414 may be wound poloidally about the toroidal vacuum device 322. In one embodiment, the field coils 414 are wound uniformly around the toroidal vacuum device 322. Alternatively, the field coils 414 may be wound intermittently around the toroidal vacuum device 322 in a plurality of separate coils. A power supply 370 may apply a current to the field coils 414.

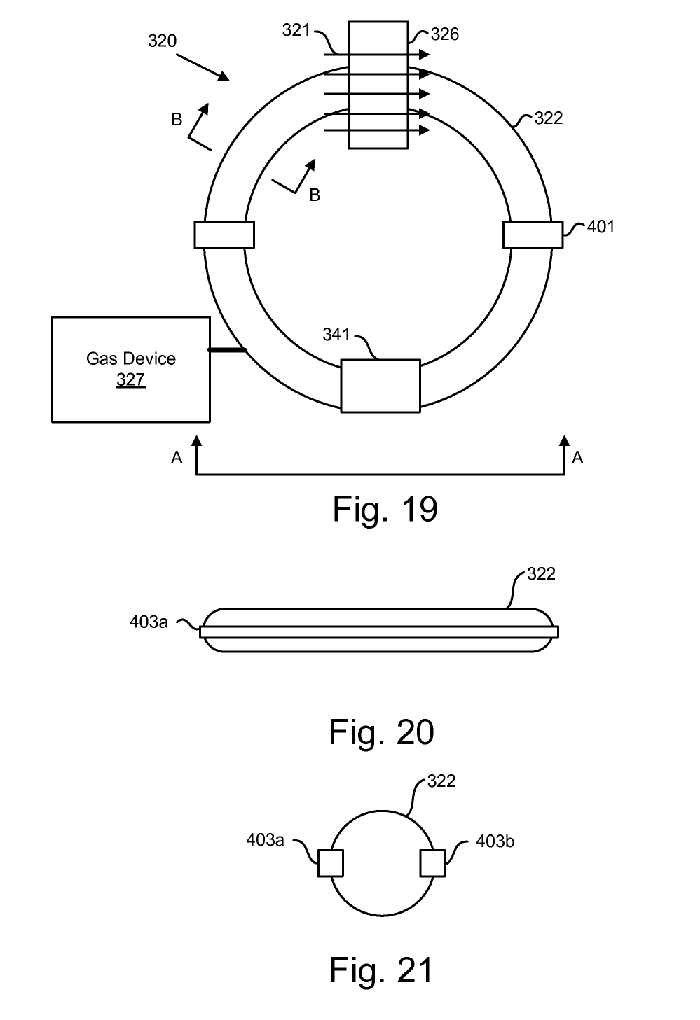

FIG. 23 is a schematic top-view drawing of one embodiment of a toroidal magnetic field 371 in the containment apparatus 320. The toroidal magnetic field 371 is depicted within the toroidal vacuum device 322 of the containment apparatus 320. For simplicity, some previously described elements of the containment apparatus 320 are not shown. The description of the toroidal magnetic field 371 refers to elements of FIGS. 1-22, like numbers referring to like elements.

The toroidal magnetic field 371 is generated by the field coils 414. In one embodiment, a current from the power supply 370 is applied to the field coils 404 to generate the toroidal magnetic field 371.

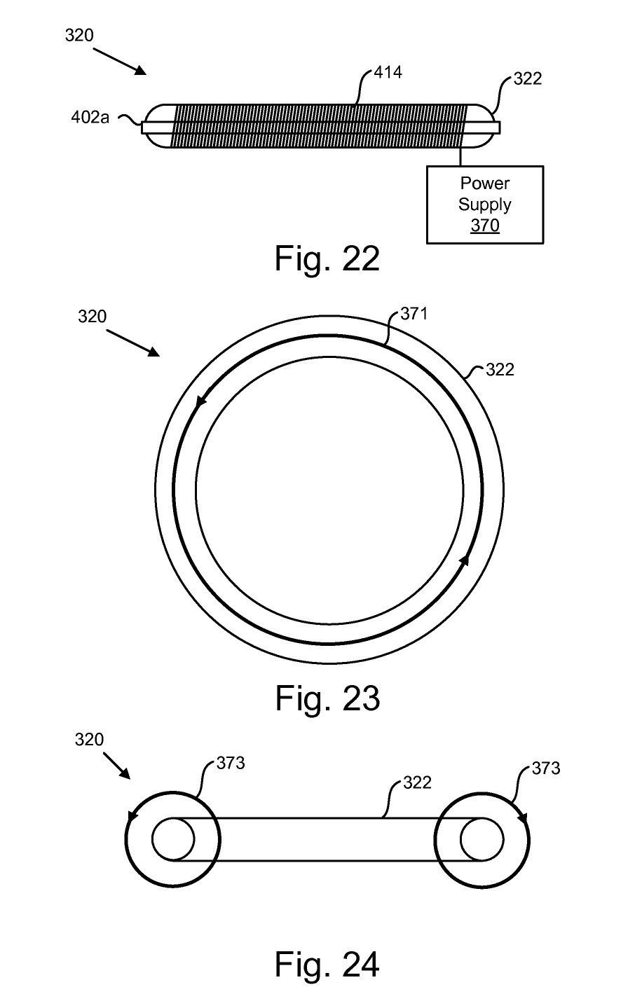

FIG. 24 is a schematic cutaway drawing of one embodiment of a poloidal magnetic field 373. The poloidal magnetic field 373 is shown about the toroidal vacuum device 322 of the containment apparatus 320. For simplicity, some previously described elements of the containment apparatus 320 are not shown. The description of the poloidal magnetic field 373 refers to elements of FIGS. 1-23, like numbers referring to like elements.

In one embodiment, the transformer 326 generates the axial electric field 321 of FIG. 19. The axial electric field 321 inductively drives the first particle current 332 about the toroidal axis 213. The first particle current 332 generates the poloidal magnetic field 373.

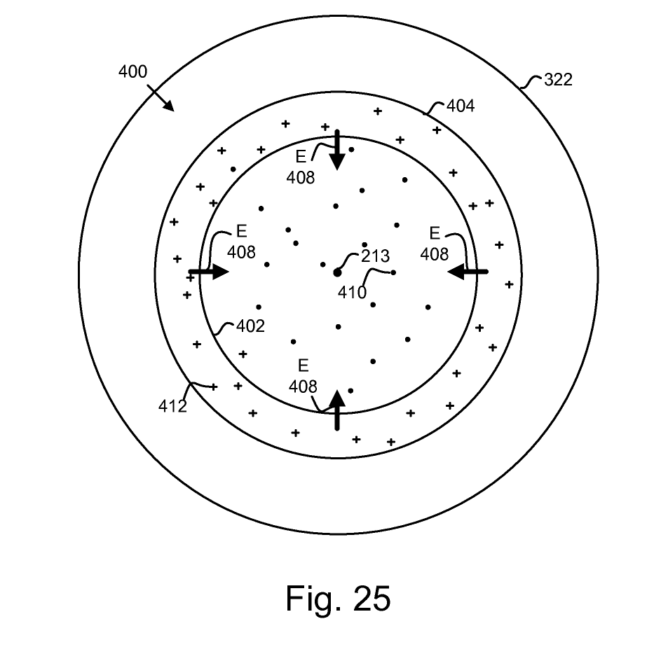

FIG. 25 is a schematic cutaway drawing illustrating one embodiment of a separation of particles. A cross-section of the toroidal vacuum device 322 is shown. The description of the separation of particles refers to elements of FIGS. 1-24, like numbers referring to like elements. First particles 410 in the plasma 400 are depicted as separating from second particles 412.

The poloidal magnetic field 373 and toroidal magnetic field 371 confine the first particles 410 and the second particles 412 of the plasma 400 within an outer boundary 404. The poloidal magnetic field 373 and toroidal magnetic field 371 further motivate the first particles 410 radially inward toward the toroidal axis 213 to within an inner boundary 402, separating the first particles 410 radially inward from the second particles 412. The separation of the particles 410, 412 produces the radial electric field 408 within the plasma 400 between the first particles 410 which are radially inward toward the toroidal axis 213 and the second particles 412 radially outward from the toroidal axis 213.

The electric field 408 attracts the second particles 412 to the first particles 410, confining the second particles 412 within the outer boundary 404. The poloidal magnetic field 373 and toroidal magnetic field 371 further confine the second particles 412 and the first particles 410.

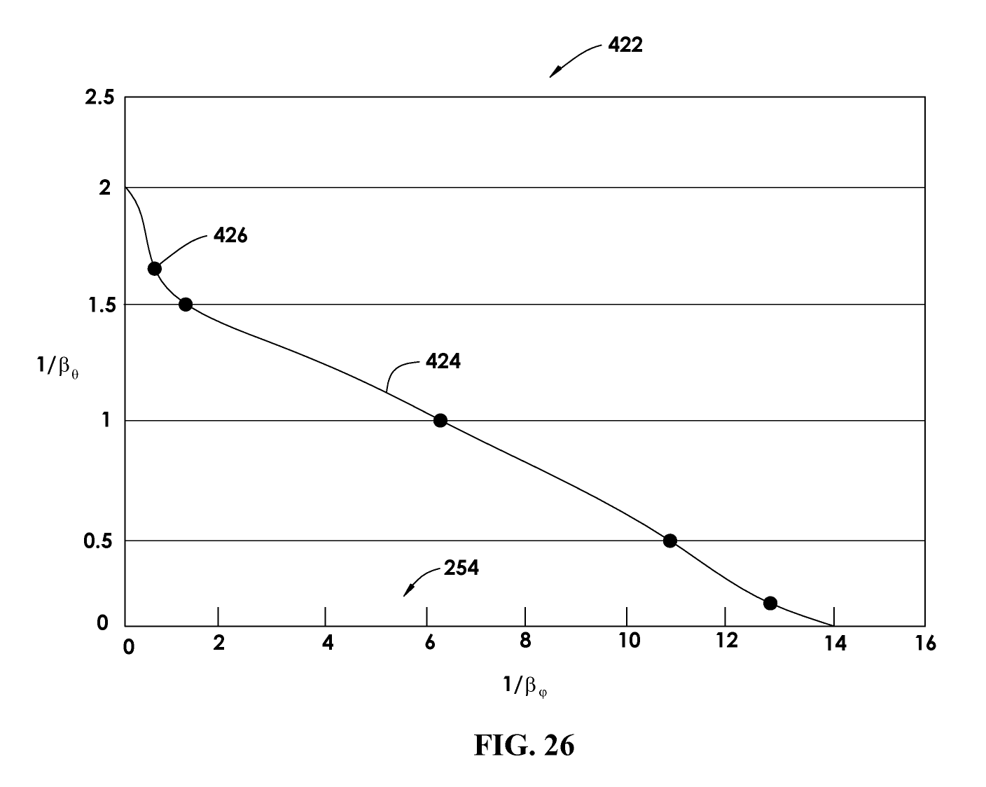

FIG. 26 is a graph 422 showing a toroidal/poloidal minimum-energy state relationship between an inverse of a first beta value 1/β_{θ} of the toroidal magnetic field 371 and an inverse of a second beta value 1/β_{φ} of the poloidal magnetic field 373. The description of the toroidal/poloidal minimum-energy state relationship refers to elements of FIGS. 1-25, like numbers referring to like elements. A plasma 400 contained in a minimum-energy state can not change from the minimum-energy state unless energy is added to the plasma 400. As a result, perturbations due to pressure perturbations, wall effects, kinetic effects, inconsistencies in magnetic and electrical fields, and the like are mitigated as the plasma 400 seeks the minimum-energy state.

The minimum-energy state is satisfied for the inverse beta value 1/β_{θ} of the toroidal magnetic field 371 and the inverse beta value 1/β_{φ} of the poloidal magnetic field 373 where β_{θ}=2 neT μ₀/B_{θ}² and β_{φ}=2 neT μ₀/B_{φ}², where n is the particle density, e is the electron charge, T is the temperature, μ₀ is the permeability of free space, and B is the magnetic field. The toroidal/poloidal minimum-energy state relationship must be satisfied for plasma 400 to be confined in the minimum-energy state.

The curve 424 illustrates a relationship between the toroidal beta β_{θ} and poloidal beta β_{φ} sufficient for the plasma to enter the minimum-energy state. The curve 424 is calculated for particular values of n, kT, and Y.

In the depicted embodiment, the curve is calculated for n=1×10¹⁹/m³, kT=100 eV, and Y=2.5 mm. The curve 424 is obtained by repeatedly solving the minimum-energy set of differential equations using different input values of magnetic field Bₜ(a)=B₀ and the toroidal current I. As seen in FIG. 26, for screw-pinch confinement that remains near a Z pinch, for example, at point 426, 1/β_{θ} could be 1.7 and 1/β_{φ} 0.5. This provides enough θ pinch to give the added stability that is expected from screw pinch. Other beta values will be obtained under different conditions, but under all conditions, 1/β_{φ} is between 0 and 3 and 1/β_{θ} between 0 and 30 to reach the minimum-energy state.

The schematic flow chart diagram that follows, as well as any preceding flow chart diagrams, are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown. The steps themselves may occur rapidly or over a longer period of time, and may be referred to as time periods.

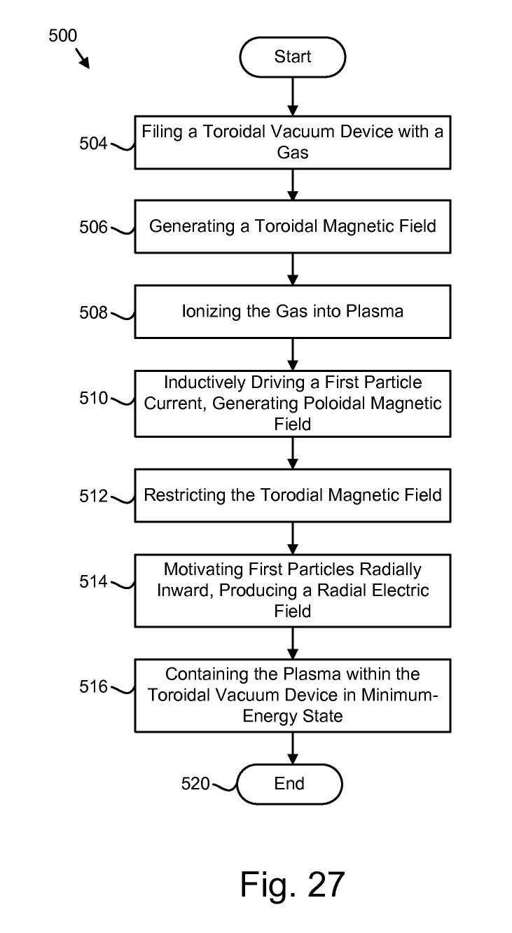

FIG. 27 is a schematic flow chart diagram showing one embodiment of a plasma containment method 500. The method 500 may heat a plasma 400 in the containment apparatus 320 from an ambient temperature into the minimum-energy state equilibrium. The description of the method 500 refers to elements of FIGS. 1-26, like numbers referring to like elements.

Although the principle of the minimum-energy equilibrium holds for many different geometries including a toroidal geometry, such as in a tokamak, and/or a linear geometry, the method 500 is illustrated with a toroidal geometry.

The method 500 starts, and the toroidal vacuum device 322 is filled 504 with the gas 391. The toroidal vacuum device 322 may have a major radius 208 R and a minor radius 212 a. In one embodiment, the major radius 208 R is 40 centimeters (cm), the minor radius 212 a is 0.20 cm.

In one embodiment, the gas valve 397 is closed, the vacuum valve 395 is opened, and the vacuum pump 394 evacuates the toroidal vacuum device 322. After the toroidal vacuum device 322 reaches a specified purging pressure, the vacuum valve 395 may be closed. In one embodiment, the specified purging pressure is in the range of 10⁻⁷ torr to 10⁻¹² torr. The evacuating of the toroidal vacuum device 322 substantially eliminates impure gases from the toroidal vacuum device 322.

The gas valve 397 may be opened and the desired fill gas 391 may flow into the toroidal vacuum device 322 until the gas 391 reaches an initial particle density n, after which the gas valve 397 is closed. The initial particle density n may be calculated using Equation (13):

n=(mη²)/(a²μₒe²) (13)

where m is the mass of the charge carrier, μ₀ is the permeability of free space, e is the electron charge, a is the minor radius 212 of the toroidal vacuum device 322, and η is a constant in the range of 1 to 2. In a certain embodiment, η is 1.6.

For gas fills consisting of more than one ion species, the value of n lies between the extreme values for the individual ions and can be determined by solving the set of differential equations obtained by minimizing the total energy, as illustrated above with regard to a single ion species.

The initial particle density n may also be described as a number of particles N divided by an internal length l of the toroidal vacuum device 322 about the toroidal axis 213, where N is the total number of particles per species in the chamber and l is the approximate major toroidal distance around the toroidal axis 213, l=2πR, where R is the major radius of the chamber. To illustrate a possible value for an electron mode of operation, using η=1.6, N/l has the value 2.3×10¹⁴/m. Typical values of N/l for other containment systems are much higher; for example, one small tokamak (STOR-1M) has N/l on the order of 10¹⁸/m, and larger tokamaks have N/l on the order of 10²⁰/m or higher.

While the fill gas density n of the described embodiment is small compared to standard tokamak containment systems, later compression during the minimum-energy state confinement will cause the plasma number density to be considerably higher than the initial fill gas density n.

Equation 13 is generated by conditions represented by the following equations:

a=ηΛ (14A)

Λ=(m/(μₒne²))^{1/2} (14B)

n=N/(πa²l) (14C)

Equation 14A was discovered computationally through the minimum-energy calculation described above, with η≈1.6. Equations 14B and 14C are definitions. The quantity n is the charge carrier density, μₒ is the permeability of free space, and e is the electron charge.

The field coils 414 generate 506 the toroidal magnetic field 371 (also referred to as a vacuum field) within the toroidal vacuum device 322. In one embodiment, the toroidal current is applied to the field coils 414 by the power supply 370.

The ionizing device 341 ionizes 508 the gas 391 into a plasma 400 comprising first particles 410 and second particles 412. The ionizing device 341 may ionize 508 the gas 391 using an electric field produced by magnetic induction and transformer action as explained below. Alternatively, the ionizing device 341 may ionize 508 the gas 391 into the plasma 400 using an electric field inherent in electromagnetic radiation, such as microwaves.

In one embodiment, the transformer 326 generates the axial electric field 321 that inductively drives 510 the first particle current 332 within the toroidal vacuum device 322. In an electron mode, electrons are the first particle charge carriers of first particle current 332 and ions are the second particles 412. In an ion mode, ions are the first particle charge carriers of the first particle current 332 and electrons are the second particles 412.

The first particle current 332, acting against plasma resistance, heats the plasma. The equations governing the plasma 400 are

∇×B=μₒj (14D)

and

j×B=∇p (14E)

where p is the scalar pressure and j is the net current comprising the first particle current 332 jₜ and a poloidal current jₚ.

The minor radius 212 may determine whether the containment apparatus 320 operates in the ion mode or in the electron mode. If the minor radius 212 is greater than 2 electron skin depths as calculated using equation 10, then the containment apparatus 320 will operate in the electron mode. However, if the minor radius 212 is greater than 2 ion skin depths as calculated using the mass of an ion, then the containment apparatus 320 will operate in the ion mode.

The first particle current 332 generates the poloidal magnetic field 373. The poloidal magnetic field 373 and toroidal magnetic field 371 confine the first particles 410 and the second particles 412 of the plasma 400 within the outer boundary 404.

As the first particle current 332 jₜ increases by being driven 510 by the axial electric field 321 Eₜ, a resistance of the plasma 400 decreases. The poloidal magnetic field 373 Bₚ produced by the plasma current grows and the total field B begins to deviate from purely toroidal to helical. A measure of the relative contributions of the toroidal magnetic field 371 Bₜ and the poloidal magnetic field 373 Bₚ is called a safety factor.

As expressed by Equation 14D, the poloidal magnetic field 373 produces a force on the toroidally oriented first particle current 322 that is in the inward radial direction toward the toroidal axis 213 and maintains an equilibrium against the outward radial force due to the plasma pressure gradient.

The current of the field coils 414 is modified to restrict 512 the toroidal magnetic field 371 to a boundary condition such that the first beta value or toroidal beta value β_{θ} and the second beta value or poloidal beta value β_{φ} for the poloidal magnetic field 373 satisfies the toroidal/poloidal minimum-energy state relationship as the relationship illustrated in FIG. 26.

The net magnetic field B within the toroidal vacuum device 322 has two components, the toroidal magnetic field 371 Bₜ and the poloidal magnetic field 373 Bₚ. In one embodiment, the primary contribution to the toroidal magnetic field 371 Bₜ is made by the field coils 414 of FIG. 22, although there will be some contribution from the poloidal magnetic field 373 Bₚ in the plasma 400.

The values of 1/β_{θ} and 1/β_{φ} are adjusted to values that fall on the curve 424 in FIG. 26. Exactly where on the curve 424 1/β_{θ} and 1/β_{φ} fall depends on how much of a Z-pinch or theta-pinch is sought.

In one embodiment, a second beta value β_{φ} may be calculated using equation (15).

1/β_{φ}=1/β_{φ}(0)[1−(1/β_{θ})/(1/β_{θ}(0))] (15)

wherein 1/β_{φ}(0), where β_{φ}(0) is the second beta value at t=0, β_{θ}(0) is the first beta value at t=0, 1β_{φ}(0) is greater than 0 and less than 3, 1/β_{θ}(0) is greater than 0 and less than 30. In one embodiment, the average plasma temperature is in the range of 0.1 electron volts (eV) to 100 eV. In an alternate embodiment, the average plasma temperature is in the range of 1 eV to 100 eV. When the values of 1/β_{θ} and 1/β_{φ} are adjusted to values that fall on the curve 424, the plasma 400 crosses over to the minimum-energy state equilibrium wherein the direction of the plasma bulk flow velocity v relative to B changes from substantially parallel to substantially perpendicular. The first particle current 322 and the poloidal magnetic field 373 Bₚ are already perpendicular. As a result, when the toroidal magnetic field 371 Bₜ has a low value relative to poloidal magnetic field 373 Bₚ, the angle between the total magnetic field B and the current j approaches 90°. As mentioned above, the curve 424 of FIG. 26 was obtained using particular values of n, kT, and Y. Other beta values will be obtained under different conditions, but under all conditions, 1/β_{φ} remains between 0 and 3 and 1/β_{θ} between 0 and 30 to maintain the minimum-energy state.

As the first particle current 332 further increases, the poloidal magnetic field 373 and toroidal magnetic field 371 further motivate 514 the first particles 410 radially inward toward the toroidal axis 213 and within the inner boundary 402, separating the first particles 410 radially inward from the second particles 412. As used herein, motivate refers to applying a force that moves, deflects, and/or accelerates a particle. In one embodiment, the poloidal magnetic field 373 produces a force on the toroidally oriented first particle current 322 that is toward the radial axis 213, motivating 514 the first particle current 322 radially inward. In the electron mode, the inner boundary 402 is the boundary Y described in FIG. 9A and FIG. 3. As shown in FIG. 9A, the electrons are confined within the boundary Y or inner boundary 402 while the ions extend beyond boundary Y or the inner boundary 402.

The separation of the particles 410, 412 produces a radial electric field 408 within the plasma 400 between the radially inward first particles 410 and the radially outwards second particles 412. The radial electric field 408 is oriented along the minor radius 212 a of the toroidal vacuum device 322. The radial electric field 408 attracts the second particles 412 to the first particles 410, further confining the second particles 412 within the outer boundary 404.

In an electron mode wherein the first particle current 332 is an electron current, as the toroidal magnetic field 371 Bₜ becomes small, a pinch effect from the poloidal magnetic field 373 Bₚ will cause the electron flow to develop a radially inward component, the electrons will pinch, the inner boundary 402 will reduce, and electron containment volume will diminish. The electrons and ions separate and the inwardly directed, radial electrical field 408 builds up to contain the ions as described by the minimum-energy equilibrium conditions.

The radial electric field 408, the poloidal magnetic field 373 and the toroidal magnetic field 371 contain 516 the plasma 400 within the toroidal vacuum device in a minimum-energy state within an outer of between 1 and 2 first particle skin depths. In one embodiment, within a temperature range of 0.1 eV to 100 eV, the containment 516 of the second particles 412 within the outer boundary 404 is primarily dependent on the skin depth Λₑ defined in Equation (10), with the outer boundary 404 being determined by the mass of the charge carrier and the particle density. The likelihood that this state can be reached is supported by experimental results from plasma focus devices and observations of Venus flux ropes.

A plasma focus device consists of two concentric conducting cylinders insulated from each other. The inner cylinder is shorter than the outer. In a low energy plasma focus a direct current (DC) voltage source of approximately 30 kV is applied between the two cylinders. When turned on, because of the design and placement of an insulator at the lower end, a breakdown occurs and a thin current sheath is formed between the inner and outer cylinders. Forces on the sheath due to the sheath current interacting with the magnetic field produced by current in the inner conductor drive the sheath up the device. A typical low-energy device has length 20 cm, inner and outer radii 2 cm and 5 cm respectively, and voltage 30 kV. The sheath reaches the end of the inner cylinder in ˜5μ seconds where the sheath plasma temperature has risen to ˜10 eV. This is the rundown phase of operation. When the sheath reaches the end of the inner cylinder the sheath rolls off and a pinch is formed.

In a plasma focus device, plasma is typically contained within at least 2 electron skin depths and/or 2 ion skin depths. The outer boundary 404 of plasma containment depends on the current-carrier mass and the plasma density n, and is stable over large variations of temperature and magnetic field. See L. Vahala and G. Vahala, “Filamentation in High-β Plasmas and Flux penetration in Type II Superconductors” Physics Essays Volume 4, number 2, p. 223 (1991); M. M. Milanese et al. “Filaments in the Sheath Evolution of the Dense Plasma Focus as Applied to Intense Auroral Observations,” IEEE Transactions on Plasma Science, August 2007 Vol. 35, pp. 808-812. Containment in the plasma focus appears to be substantially explained using the minimum-energy theory without taking into account kinetic effects, wall effects, and pressure perturbations.

With regard to the containment step 516, systems that are near the minimum-energy state equilibrium will relax to that state explosively. This has been observed in Venus flux ropes. According to this, when Bₚ, Bₜ, T, α, β, n, and θ (the angle between the magnetic field and the flow velocity) are near the values required for minimum-energy equilibrium, the plasma 400 will relax to the minimum-energy state through rapid internal adjustments of the outer boundary 404, internal currents, and other parameters. These adjustments also appear to mitigate perturbations such as pressure perturbations, kinetic effects, and perturbations in poloidal magnetic field 373 and radial electric field 408.

In the containment step 516, the plasma 400 will have the proper values of T, α, and β for the toroidal vacuum device 322 to contain 516 the plasma 400 in the minimum-energy state as the final containment state. These values of T, α, and β, however, represent only boundary conditions (coupled with input initial conditions) whereas the minimum-energy state specifies radial profiles of all variables. For example, T is the average temperature, the toroidal beta β_{θ} is determined by the average number density n₀, average temperature T, and toroidal current I; the poloidal beta β_{φ} is determined by n₀, T, and the boundary value of the toroidal magnetic field 371.

A proper minimum-energy set of conditions that will lead through relaxation processes to the complete equilibrium state does not require complete minimum-energy profiles; the set of conditions will lead to the proper, complete minimum-energy equilibrium. The containment apparatus 320 may achieve a minimum-energy state adjusting the toroidal magnetic field 371 and the axial electric field 321 to establish the minimum-energy-state boundary conditions. Then, through internal adjustments of internal plasma profiles, the plasma will relax to the minimum-energy state in a self-consistent manner.

As explained above, for the minimum-energy state, poloidal currents in poloidal field coils 414 and poloidal currents 186 (FIG. 4B) in the plasma 400 are oppositely directed. As a consequence of this, the diamagnetic poloidal plasma currents likely cannot be induced by means of the external windings 344. These poloidal plasma currents arise, in a self-consistent manner, as a consequence of the plasma 400 lowering the plasma magnetic energy by reducing the toroidal magnetic field 371. This reduction is accompanied (as required by Faraday's law and the Lorentz force equation) by internal inductive electrical forces that drive the internal plasma current 186 (as required by Ampere's law) in a self consistent manner.

According to the present invention, establishing the appropriate set of conditions and parameters, including boundary conditions, will produce the minimum-energy profiles. It is well-known that physical systems that are in equilibrium states having higher energy than corresponding minimum-energy equilibrium states are often unstable to small perturbations that tend to lower the energy. These instabilities rapidly move the system away from higher-energy equilibria toward the lower energy states. Changes of this nature are sometimes called relaxation processes. In one embodiment, internal plasma resistance aids the relaxation process.

In the minimum-energy containment state of step 516 the axial electric field 321 Eₜ will continue to heat the plasma 400, although the heating is progressively less ohmic and more compressional. The plasma 400 will substantially remain in the minimum-energy equilibrium with parameter adjustments tracking the heating due to the axial electric field 321 Eₜ. Inasmuch as the equilibrium parameters themselves change as heating continues, the minimum-energy state is called quasi minimum-energy equilibrium.

In the minimum-energy state containment step 516, any perturbations including changes in the radial electric field 408 and changes in the polodial magnetic field 373 are rapidly mitigated as the plasma 400 relaxes to the minimum-energy state. This is consistent with observed natural minimum-energy state plasmas such as the Venus flux ropes where plasmas remain in the minimum-energy state for extended periods despite constant environmental perturbations.

As the plasma enters the minimum-energy quasi-equilibrium state the plasma 400 increasingly will not be forced to maintain an outer boundary 404 having a radius that is constant (i.e., fixed in time). Instead the plasma 400 will compress or pinch. This compression will cause the temperature to increase, likely by many factors, over and above that produced by the ohmic heating. For temperatures exceeding a few keV, compression will be by far the primary source of heat. For the electron mode of operation, compression will heat ions even without equilibration of energy from electrons to ions.

After achieving the minimum-energy containment quasi equilibrium, in addition to appropriate boundary conditions, one will have the correct profiles for all radius-dependent variables: T(r), Bₜ(r), Bₚ(r), nₑ(r), nᵢ(r), vₑ(r), vᵢ(r), and so on. Nevertheless, one can make time-dependent calculations that will give approximations of the time-dependent pinch parameters. These calculations are simplified to eliminate radial dependence of the various quantities. The plasma parameters include time dependent values for temperature T(t), number density n(t), and radius a(t). Despite this simplification, the general behavior of the actual plasma is expected to approximately follow these results and, consequently, the calculations are adequate for device design.

Assuming the random velocity distributions that represent temperature are Maxwellian. Although gradients in number density n and temperature T (and consequently in pressure) are necessary during both stages of heating, a reasonable estimate of the heat produced can be determined by assuming that radial number density n(r) and radial temperature T(r) are constant (i.e., have no radial dependence). This assumption also negates the need to consider radial heat transport which, for our purposes, is reasonable.

For convenience we calculate the heating of the plasma in the Z pinch mode, although in actual operation stability will be enhanced through introduction of some θ pinch.

Based on the foregoing assumptions, calculations of the time-dependent behavior of plasma parameters as the plasma is being heated follow:

Consider a volume

V=πa²l (17)

where a is the minor radius 212 of the toroidal vacuum device 322, assumed for these purposes to be substantially the same for both electrons and ions and l is the length of the approximate cylindrical volume

l=2πR (18)

where R is the major radius 208 of the toroidal vacuum device 322. Using σ to represent the conductivity of the plasma 400 and j the current density, production of heat energy Q through resistance in volume V will be

dQ/dt=j²V/σ (19)

In a two-species plasma, the conductivity is obtained, in terms of the electron-ion collision frequency v, by

σ=ne²/(mv) (20)

An estimate of the collision frequency is

v=κn/(kT)^{3/2} (21)

where κ depends upon the slowly varying coulomb logarithm (taken to be 10) and other parameters. For purposes of this illustration we take κ to be 2.9×10⁻¹¹ eV^{3/2}m³/s.

The Second Law of Thermodynamics is

dQ=dU+dW (22)

where U is the internal energy and W is the work done on the system by changes in volume. For t<t₂ there is no change in volume, hence

dW=0 (23)

however for t>t₂

dW=pdV (24)

where p is the pressure.

Internal energy is given by

U=(3/2)NkT (25)

where N is the total number of particles in the system.

Plasma pressure is, by the ideal gas law,

p=nkT (26)

The total number of particles (see Equation 14C) is

N=nV (27)

hence dV=−Ndn/n².

The magnitude of the poloidal component of the magnetic field intensity Bₚ at r=a is, from Amperes Law,

Bₚ=μₒI/(2πa) (28)

where μₒ is the permeability of free space, and the current I is given in terms of the current density, and the velocity of the charge carriers,

I=jπa² (29)

and j is expressed in terms of the velocity of the charge carriers, v,

j=nev (30)

Acceleration of the charge carriers and consequent heating is caused by the toroidal electric field E(t) that is induced through the transformer action previously discussed. This acceleration of the charge carriers also does work to increase the magnetic field and is resisted by the ohmic resistance.

mdv/dt=eE−ej/σ+[L/(2πR)]dI/dt (31)

L is the inductance of the single loop of plasma. This we estimate through

L=Rμₒ ln(8R/a) (32)

which neglects internal inductance. It is convenient to indicate the radius in terms of the penetration depth or scale factor Λ. Using η to represent the proportionality factor, this gives

a=ηΛ (33)

where Λ is given as earlier in equation (10) as:

Λ=[m/(μₒne²)]^{1/2}. (34)

As discussed earlier, we define a toroidal beta value β_{θ} for Z-pinch operation,

β_{θ}=nkT(2μₒ)/Bₚ² (35)

where Bₚ is the magnitude of the poloidal component of the magnetic field. Note that the actual plasma beta as conventionally defined requires the use of the total magnetic field rather than the poloidal component. The total magnetic field is 1/(1/β_{φ}+1/β_{θ}). Since these calculations are for a z-pinch configuration, β_{φ}=0.

All of the foregoing equations are evident from physical laws and definitions that follow from the assumptions made concerning this simple plasma system.

Prior to the minimum-energy containment state, dW=0, the outer boundary is constant, and n is constant. During this time period Equations (A) through (R) reduce to two nonlinear, first-order, ordinary differential equation for v(t) and T(t) as follows:

$$\begin{matrix}\frac{d v}{d t} = [ \frac{eE}{m} - \frac{κ {n}_{0} v}{{( kT )}^{3 / 2}} ] {( 1 + 0.5 ln ( 8 \frac{R}{a} ) )}^{- 1} & ( 36 ) \\ \frac{d ( kT )}{d t} = \frac{2 m κ {n}_{0} {v}^{2}}{3 {( kT )}^{3 / 2}} & ( 37 )\end{matrix}$$

In the minimum-energy state, the volume can change, so (G′) is used. Two restrictions on Equations (A) through (R) are required in order for the state to be minimum energy: First, as established earlier in Equations 13-14C, when the plasma is in the optimal minimum-energy state, η is a constant between 1 and 2. In an exemplary embodiment, this constant to be 1.6. Second, as established earlier for a Z-pinch plasma in the minimum-energy quasi equilibrium, the toroidal beta value β_{θ} is nearly constant (almost independent of all input and plasma parameters) at a value near ½. For convenience, and to illustrate the heating behavior, we take β_{θ}=½ and β_{φ}=0. These limitations effectively put this system into the quasi minimum-energy state. The minimum-energy equilibrium is maintained as other plasma parameters change and the plasma heats.

In the minimum-energy state, Equations 17 through 35 reduce to two nonlinear, first-order, ordinary, differential equations in two unknowns. These are:

$$\begin{matrix}\frac{d v}{d t} = ( eE / m - \frac{κ n {8}^{3 / 2}}{{m}^{3 / 2} {v}^{2}} ) \cdot {( 1 + 0.5 ln ( 8 \frac{R}{a} ) )}^{- 1} & ( 38 ) \\ \frac{d n}{d t} = \frac{3 n}{v} \cdot [ ( \frac{eE}{m} + \frac{κ n {8}^{3 / 2} ln ( 8 R / a )}{{m}^{3 / 2} {v}^{2}} ) \cdot ( {( 1 + 0.5 ln ( 8 R / a ) )}^{- 1} - \frac{{11.8}^{3 / 2} κ n}{3 {m}^{3 / 2} {v}^{2}} ) ] & ( 39 )\end{matrix}$$

where a=η(m/μₒne²)^{1/2}.

To give an explicit illustration of the solution of these equations we supply values for e, m, κ, and take R=0.44 m and a=0.010 m. In order for the minimum-energy state to be robust we use, for both time periods, N/l=2.3×10¹⁴. This, with the assumed value of a, determines n(0) through Equations 14C and 18. We use η=1.6 and the parameters that specify the minimum-energy state for a Z-pinch plasma, 1/α=2 and 1/β=0. At v(0) the equations are solved using Mathcad for n(t) and v(t).

Using various combinations of Equations 17-35, from solutions v(t) and n(t) we obtain T(t), B(t), n(t), and a(t). For example we determine that

(U)T(t)=mv(t)²/(8k) (40)

This gives the heating and compression of the electron fluid. We have assumed that electrons and ions equilibrate immediately and that ion temperature is the same as electron temperature, although it is clear that the temperature of the ion fluid would lag that of the electrons even though its heating during the minimum-energy containment is primarily compressional.

Consideration of heat transport throughout the plasma is not necessary with this calculation, although in a better determination where we consider profiles n(r), v(r), etc., it would be necessary. Again, the development of the plasma should follow this calculation, more or less, and the general behavior would be as indicated.

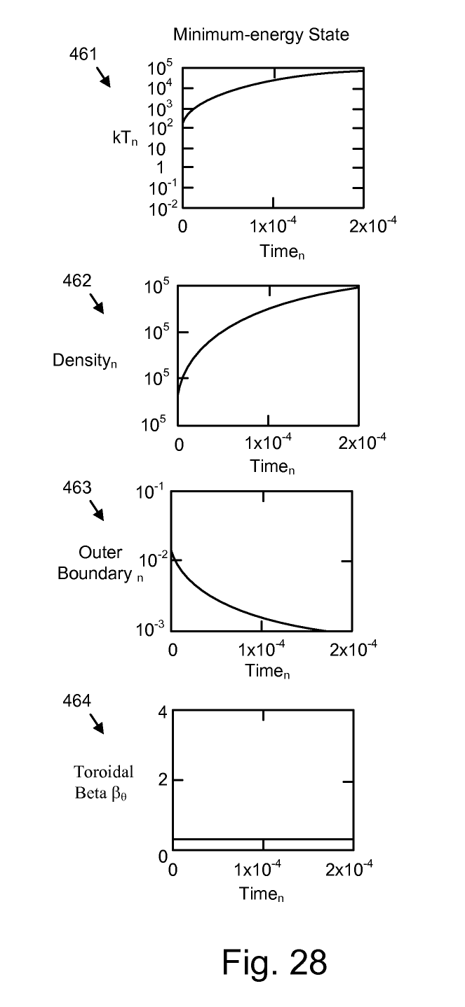

FIG. 28 is a collection of graphs showing one embodiment of a profile of plasma parameters as a function of time in the minimum-energy containment state. During the minimum-energy state containment step 516, as shown in the column of graphs for one exemplary embodiment, kT(t_{c})=62 eV and v(t_{c})=8.2×10⁶ m/s are input values for solving Equations 38 and 39, where the zero axis of the time axis is time t_{c}, a start of the minimum-energy containment state. Most of the heating is compressional. The graphs include values as functions of time for the temperature kT 461, the number density n 462, the outer boundary 404, and the toroidal beta β_{θ} 464.

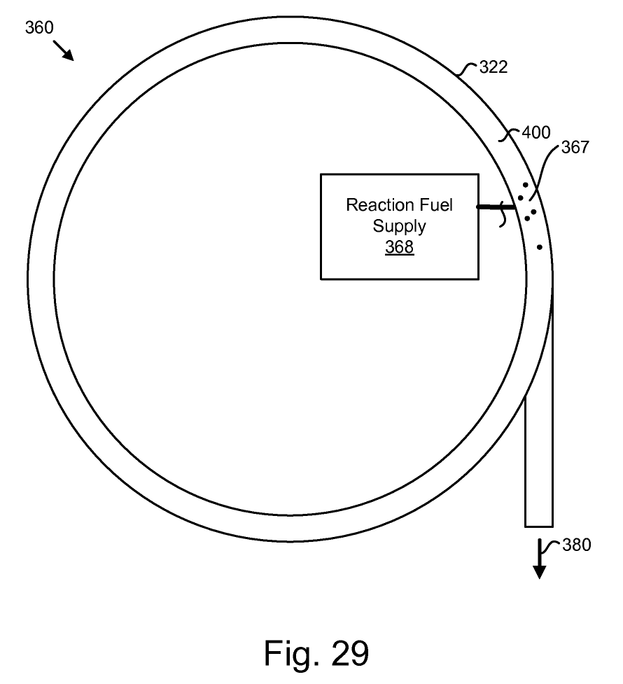

FIG. 29 shows a top-view schematic drawings of one embodiment of a reaction apparatus 360. The reaction apparatus 360 embodies the containment apparatus 320 including the toroidal vacuum device 322 of FIG. 19, although for simplicity some elements of the containment apparatus 320 are not shown. The description of the reaction apparatus 360 refers to elements of FIGS. 1-28, like numbers referring to like elements

The toroidal vacuum device 322 has a high aspect ratio toroidal geometry, wherein the major radius 208 R is at least ten times the minor radius 212 a. The reaction apparatus 360 employs the toroidal magnetic field 371, the poloidal magnetic field 373, and the radial electric field 408 to contain 518 the plasma 400 within the toroidal vacuum device 322.

The reaction apparatus 360 further includes a reaction fuel supply 368 that provides a reaction fuel for the plasma 400. The plasma 400 may be contained 518 in the minimum-energy state with the electron mode distribution, wherein the first particles 410 are electrons and the second particles 412 are ions. In an alternate embodiment, the first particles 410 are ions and the second particles 412 are electrons.

With the plasma 400 contained in the minimum-energy state, the toroidal vacuum device 322 may have a relatively small dimension. For example, the outer boundary 404 may be 1.5Λₑ or 0.080 cm, the minor radius a may be 2.5Λₑ or 0.20 cm and the major radius R may be 20a or 4 cm. Such a small size allows the reaction apparatus 360 to used in a wide range of particle generation applications such as photolithography, antiterrorist materials detection, well logging, underground water monitoring, radioactive isotope production, and other applications.

The reaction fuel supply 368 introduces a fuel 367 into the toroidal vacuum device 322. The fuel may be deuterium-tritium (DT). The plasma 400 may react with the fuel 367 to generate one or more particle streams 380. The particle streams 380 may comprise one or more streams of neutrons, x-rays, soft x-rays.

In one embodiment, the DT-fueled plasma 400 yields high intensity soft x-rays having energies in a range of approximately 1-5 keV. Such x-rays from such compact device are useful in areas such as photolithography. In one embodiment, the soft x-rays are produced from the plasma even if fusion does not occur.

Some of the possible reaction configurations and particles streams 380 for an example DT reaction at various example operating conditions are summarized in Tables 1-2.

Table 1 summarizes various dimensions associated with an electron-scaled high aspect ratio toroidal system at various particle densities. Quantities associated with Table 1 are defined as follows: n=average particle density; Λ=electron scale length; the inner boundary 7 402=1.5Λ; the minor radius a 212=outer boundary 404=2.5 Y; the major radius R 208=20a; the toroid's volume V=2π²Ra².

TABLE 1

| | | | | | |
|---|---|---|---|---|---|
| n(m⁻³) | 1.00 × 10¹⁹ | 1.00 × 10²⁰ | 1.00 × 10²¹ | 1.00 × 10²² | 1.00 × 10²³ |
| Λ (cm) | 1.68 × 10⁻¹ | 5.32 × 10⁻² | 1.68 × 10⁻² | 5.32 × 10⁻³ | 1.68 × 10⁻³ |
| Y (cm) | 2.52 × 10⁻¹ | 7.98 × 10⁻² | 2.52 × 10⁻² | 7.98 × 10⁻² | 2.52 × 10⁻² |
| α (cm) | 6.31 × 10⁻¹ | 2.00 × 10⁻¹ | 6.31 × 10⁻² | 2.00 × 10⁻² | 6.31 × 10⁻³ |
| R (cm) | 1.26 × 10¹ | 3.99 × 10⁰ | 1.26 × 10⁰ | 3.99 × 10⁻¹ | 1.26 × 10⁻¹ |
| V (cm³) | 9.90 × 10¹ | 3.13 × 10⁰ | 9.90 × 10⁻² | 3.13 × 10⁻³ | 9.90 × 10⁻⁵ |

Table 2 summarizes various neutron production rate estimates with the system of Table 1 at various temperatures. Quantities associated with Table 2 are defined as follows: T=plasma temperature; σv=reaction rate; neutron rate=n²(σv)V/4. These reaction rate and neutron rate expressions are well known in the art.

TABLE 2

| | σν | Neutron rate (s⁻¹) | | | | |
|---|---|---|---|---|---|---|
| (keV) | (cm³/s) | n = 10¹⁹ m⁻³ | n = 10²⁰ m⁻³ | n = 10²¹ m⁻³ | n = 10²² m⁻³ | n = 10²³ m⁻³ |
| 1 | 5.50 × 10⁻²¹ | 1.36 × 10⁷ | 4.30 × 10⁷ | 1.36 × 10⁸ | 1.36 × 10⁸ | 1.36 × 10⁹ |
| 2 | 2.60 × 10⁻¹⁹ | 6.44 × 10⁸ | 2.03 × 10⁹ | 6.44 × 10⁹ | 2.03 × 10¹⁰ | 6.44 × 10¹⁰ |
| 5 | 1.30 × 10⁻¹⁷ | 3.22 × 10¹⁰ | 1.02 × 10¹¹ | 3.22 × 10¹¹ | 1.02 × 10¹² | 3.22 × 10¹² |
| 10 | 1.10 × 10⁻¹⁶ | 2.72 × 10¹¹ | 8.61 × 10¹¹ | 2.72 × 10¹² | 8.61 × 10¹² | 2.72 × 10¹³ |
| 20 | 4.20 × 10⁻¹⁶ | 1.04 × 10¹² | 3.29 × 10¹² | 1.04 × 10¹³ | 3.29 × 10¹³ | 1.04 × 10¹⁴ |
| 50 | 8.70 × 10⁻¹⁶ | 2.15 × 10¹² | 6.81 × 10¹² | 2.15 × 10¹³ | 6.81 × 10¹³ | 2.15 × 10¹⁴ |
| 100 | 8.50 × 10⁻¹⁶ | 2.10 × 10¹² | 6.65 × 10¹² | 2.10 × 10¹³ | 6.65 × 10¹³ | 2.10 × 10¹⁴ |

As an example from Tables 1-2, not to be construed as limiting in any manner, consider a plasma system having a DT fuel 367 contained 516 in the toroidal vacuum device 322. An average number density n of approximately 10²⁰ m⁻³ corresponds to an electron scale length Λ of approximately 0.0532 cm. Setting Y=1.5Λₑ=0.080 cm, the minor radius 212 a at 2.5Λₑ=0.20 cm, the major radius 208 R at 20a=4 cm results in a volume V of approximately 3.13 cm³.

Operating such a plasma 400 at a temperature of approximately 5 keV (where the reaction rate is approximately 1.30×10⁻¹⁷) can yield approximately 1.02×10¹¹ neutrons per second. Neutron fluxes of such an order in such a compact device are useful in many areas such as antiterrorist materials detection, well logging, underground water monitoring, radioactive isotope production, and other applications.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for plasma containment, comprising:
filling a toroidal vacuum device with a major radius R and a minor radius a with a gas having an initial particle density n, where n=(mη²)/(a²μₒe²), m is a mass of an individual charge carrier, μ₀ is the permeability of free space, e is the electron charge, and η is a constant in the range of 1 to 2;
generating a toroidal magnetic field with field coils wound poloidally about the toroidal vacuum device;
ionizing the gas into a plasma comprising first particles and second particles;
inductively driving a toroidal first particle current about a toroidal axis that heats the plasma and generates a poloidal magnetic field;
restricting the toroidal magnetic field to a boundary value such that a first beta value β_{θ} for the toroidal magnetic field and a second beta value β_{φ} for the poloidal magnetic field approximately satisfies the equation 1/β_{φ}=1/β_{φ}(0)[1−(1/β_{θ})/(1/β_{θ}(0))], wherein 1/β_{φ}(0) is greater than 0 and less than 3, 1/β_{θ}(0) is greater than 0 and less than 30, and an average plasma temperature is in the range of 0.1 electron volts (eV) to 100 eV;
motivating the first particles radially inward toward the toroidal axis in response to the poloidal magnetic field and the toroidal magnetic field, separating the first particles radially inward from the second ions, the first particles contained within an inner boundary and the second particles contained within an outer boundary, and producing a radial electric field within the plasma between the radially inward first particles and the radially outward second particles;
containing the plasma with the radial electric field, the poloidal magnetic field, and the toroidal magnetic field within the toroidal vacuum device in a minimum-energy state within the outer boundary of between 1 and 2 first particle skin depths.

2. The method of claim 1, wherein the first particles are electrons and the second particles are ions.

3. The method of claim 1, wherein the first particles are ions and the second particles are electrons.

4. The method of claim 1, wherein the major radius R is 40 centimeters (cm), the minor radius a is 0.20 cm, and η is 1.6.

5. The method of claim 1, wherein the electron skin depth Λₑ is calculated as Λₑ=(mₑ/μₒN₀ e²)^{1/2} where mₑ is a mass of an electron and N₀ is an initial number of gas atoms.

6. The method of claim 1, wherein the plasma is contained in the containment state within a time τ calculated as τ=[μₒe²a²(kT)^{3/2} ln(8R/a)]/(2mκ).

7. The method of claim 1, wherein the average plasma temperature is in the range of 1 eV to 100 eV.

8. An apparatus comprising:
a toroidal vacuum device with a major radius R and a minor radius a filled with a gas having an initial particle density n, where n=(mη²)/(a²μₒe²), m is a mass of an individual charge carrier, μ₀ is the permeability of free space, e is the electron charge, and η is a constant in the range of 1 to 2;
field coils wound poloidally about the toroidal vacuum device and generating a toroidal magnetic field;
an ionizing device ionizing the gas into a plasma comprising first particles and second particles;
a transformer inductively driving a toroidal first particle current about a toroidal axis that heats the plasma and generates a poloidal magnetic field;
the field coils restricting the toroidal magnetic field to a boundary value such that a first beta value β_{θ} for the toroidal magnetic field and a second beta value β_{φ} for the poloidal magnetic field approximately satisfies the equation /β_{φ}=1/β_{φ}(0)[1−(1/β_{θ})/(1/β_{θ}(0))], wherein 1/β_{φ}(0) is greater than 0 and less than 3, 1/β_{θ}(0) is greater than 0 and less than 30, and an average plasma temperature is in the range of 0.1 electron volts (eV) to 100 eV; and
the poloidal magnetic field and the toroidal magnetic field motivating the first particles radially inward toward the toroidal axis, separating the first particles radially inward from the second ions, the first particles contained within an inner boundary and the second particles contained within an outer boundary, and producing a radial electric field within the plasma between the radially inward first particles and the radially outward second particles; and
the radial electric field, the poloidal magnetic field, and the toroidal magnetic field containing the plasma within the toroidal vacuum device in a minimum-energy state within the outer boundary of between 1 and 2 first particle skin depths.

9. The apparatus of claim 8, wherein the first particles are electrons and the second particles are ions.

10. The apparatus of claim 8, wherein the first particles are ions and the second particles are electrons.

11. The apparatus of claim 8, wherein the major radius R is 40 centimeters (cm), the minor radius a is 0.20 cm, and η is 1.6.

12. The apparatus of claim 8, wherein the electron skin depth Λₑ is calculated as Λₑ=(mₑ/μₒN₀ e²)^{1/2} where mₑ is a mass of an electron and N₀ is an initial number of gas atoms.

13. The apparatus of claim 8, wherein the plasma is contained in the final containment state within a time τ calculated as τ=[μₒe²a²(kT)^{3/2} ln(8R/a)]/(2mκ).

14. The apparatus of claim 8, wherein the average plasma temperature is in the range of 1 eV to 100 eV.
